(19) United States
(12) Patent Application Publication
(10) Pub. No.: US 2026/0322811 A1
(43) Pub. Date: Oct. 15, 2026

(54) INFORMATION PROCESSING METHOD, COMPUTER PROGRAM PRODUCT, AND INFORMATION PROCESSING APPARATUS

(71) Applicant: Panasonic Intellectual Property Management Co., Ltd., Osaka (JP)

(72) Inventors: Shunsuke KUHARA, Osaka Fu (JP); Yoshimasa HONDA, Hyogo Ken (JP)

(73) Assignee: Panasonic Intellectual Property Management Co., Ltd., Osaka (JP)

(21) Appl. No.: 19/467,089

(22) Filed: Feb. 2, 2026

Related U.S. Application Data
(63) Continuation of application No. PCT/JP2023/044931, filed on Dec. 14, 2023.
(60) Provisional application No. 63/535,945, filed on Aug. 31, 2023.

(51) Int. Cl. H04L 9/40

(52) U.S. Cl. CPC H04L 63/0876

(57) ABSTRACT

An information processing method is executed by an information processing apparatus. The method includes: receiving remote control request information from a mobile object; and determining, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

### CROSS-REFERENCE TO RELATED APPLICATIONS

This application is a continuation of PCT International Application No. PCT/JP2023/044931, filed on Dec. 14, 2023 which claims the benefit of priority from U.S. Patent No. 63/535,945, filed on Aug. 31, 2023, the entire contents of which are incorporated herein by reference.

### FIELD

An embodiment of the present invention relates to an information processing method, a computer program product, and an information processing apparatus.

### BACKGROUND

Systems for remotely controlling mobile objects capable of autonomous movement are known. For example, there is disclosed a system that, when an exceptional event or the like occurs and a robot falls into a situation where it is difficult to move autonomously, enables the robot to be remotely controlled by a remote operator to handle the exceptional event. In addition, there is disclosed a technology for allocating a remote operator in a work environment suitable for a remote request received from a mobile object as a remote operator to handle an exceptional event.

However, in the related art, a remote operator is not allocated according to the need of a service manager who is an entity managing a service using a mobile object.

A related technology is described in JP 2020-42764 A.

The present invention is made in view of the above and has an object to provide an information processing method, a computer program product, and an information processing apparatus capable of allocating remote operators according to the need of the service manager.

### SUMMARY

An information processing method according to an embodiment is executed by an information processing apparatus. The method includes: receiving remote control request information from a mobile object; and determining, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

### BRIEF DESCRIPTION OF THE DRAWINGS

FIG. 1 is an explanatory diagram of an example of a remote control system according to an embodiment;

FIG. 2 is a functional block diagram of an example of a mobile object;

FIG. 3 is a functional block diagram of an example of a service manager terminal;

FIG. 4 is a functional block diagram of an example of a remote control terminal;

FIG. 5 is a functional block diagram of an information processing apparatus;

FIG. 6 is a schematic diagram illustrating an example of a data configuration of mobile object management information;

FIG. 7 is a schematic diagram illustrating an example of a data configuration of area management information;

FIG. 8 is a schematic diagram illustrating an example of a data configuration of remote operator management information;

FIG. 9 is a schematic diagram of an example of a data configuration of remote control history information;

FIG. 10 is a flowchart illustrating an example of a flow of information processing executed by a control unit of the information processing apparatus;

FIG. 11 is a schematic diagram of an example of a screen on which operator selection reference information is displayed; and

FIG. 12 is a hardware configuration diagram.

### DETAILED DESCRIPTION

Hereinafter, an embodiment for an information processing method, an information processing program, and an information processing apparatus will be described in detail with reference to the accompanying drawings.

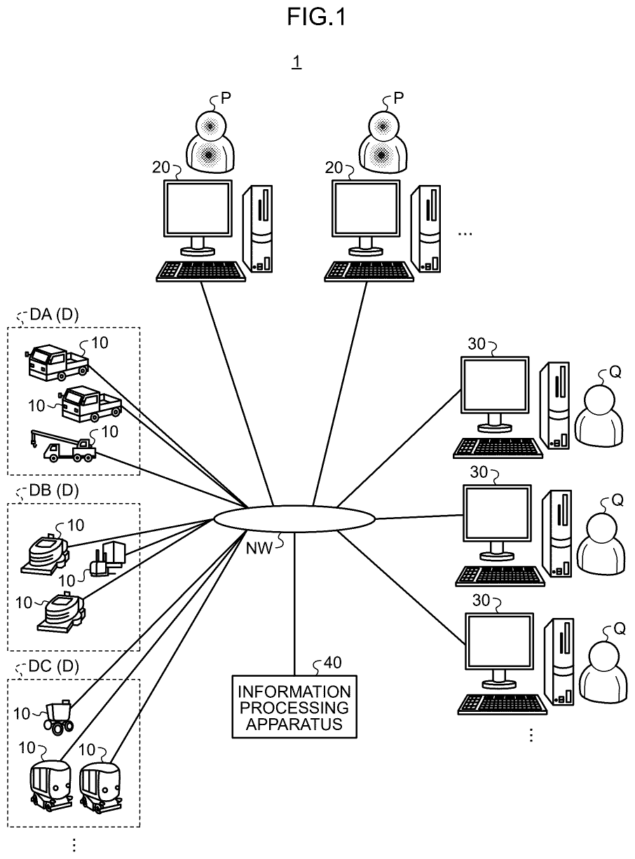

FIG. 1 is an explanatory diagram of an example of a remote control system 1 according to the present embodiment.

The remote control system 1 includes a mobile object 10, a service manager terminal 20, a remote control terminal 30, and an information processing apparatus 40. The mobile object 10, the service manager terminal 20, the remote control terminal 30, and the information processing apparatus 40 are communicably connected to each other via a network NW or the like.

The mobile object 10 is an object that autonomously moves and can be remotely controlled. The mobile object 10 is, for example, an autonomously moving vehicle, an autonomously moving robot equipped with a moving function, or the like. The autonomously moving vehicle may be referred to as an autonomous driving vehicle.

In the present embodiment, the mobile object 10 provides various services in a service providing area which is set by a service manager P and which the mobile object 10 is in charge of. For example, the mobile object 10 provides various services such as selling goods, road maintenance, and construction work in service providing areas such as plants, airports, and harbors. In addition, for example, the mobile object 10 provides a service such as delivery of goods in a service providing area such as a public road.

FIG. 1 illustrates, as an example, a mode in which a plurality of mobile objects 10 provides services in predetermined areas D (areas DA to DC) that the respective mobile objects 10 are in charge of. The mobile objects 10 autonomously travel in the areas D that the respective mobile objects 10 are in charge of and provide predetermined services.

In a case where the mobile object 10 needs remote control by a remote operator Q, such as when it is difficult to move autonomously, the mobile object 10 transmits remote control request information to the information processing apparatus 40. The remote control request information will be described in detail later.

The service manager terminal 20 is an information processing apparatus operated by the service manager P. The service manager P is an entity that provides a service using the mobile object 10. In other words, the service manager P is a provider or manager of a service provided by the remote control system 1. For example, in a case where the mobile object 10 provides a conveyance service for conveying goods, the service manager P creates and manages service specifications such as an area D in which the mobile object 10 provides the service, a point to which the goods are conveyed in the area D, the mobile object 10 that executes the service, and information regarding traveling rules of the mobile object 10, and manages costs required for the service.

The remote control terminal 30 is an information processing apparatus operated by the remote operator Q. The remote operator Q is an operator that remotely controls the mobile object 10. The remote operator Q remotely controls the mobile object 10 allocated to the remote operator Q by the information processing apparatus 40 (details will be described later). In addition, a remuneration corresponding to the remote control is paid to the remote operator Q from at least one of the information processing apparatus 40 and the service manager P (details will be described later). In the following description, the remuneration refers to an amount paid to the remote operator Q. In addition, charging refers to charging the service manager P.

Note that, in the present embodiment, a mode in which the remote operator Q is a user existing outside the local network to which the information processing apparatus 40 belongs, and operates the remote control terminal 30 existing outside the local network will be described as an example. However, the remote operator Q may be a user existing in the local network to which the information processing apparatus 40 belongs, and may operate the remote control terminal 30 existing in the local network.

The information processing apparatus 40 manages mobile objects 10 and remote operators Q included in the remote control system 1. In addition, the information processing apparatus 40 receives and manages a service manager-requested condition of the service manager P from the service manager terminal 20 operated by the service manager P. In addition, based on the remote control request information received from the mobile object 10, the information processing apparatus 40 determines a remote operator to execute remote control of the mobile object 10 from which the remote control request information has been transmitted. These processes will be described in detail later.

Next, a functional configuration of each of the mobile object 10, the service manager terminal 20, the remote control terminal 30, and the information processing apparatus 40 will be described.

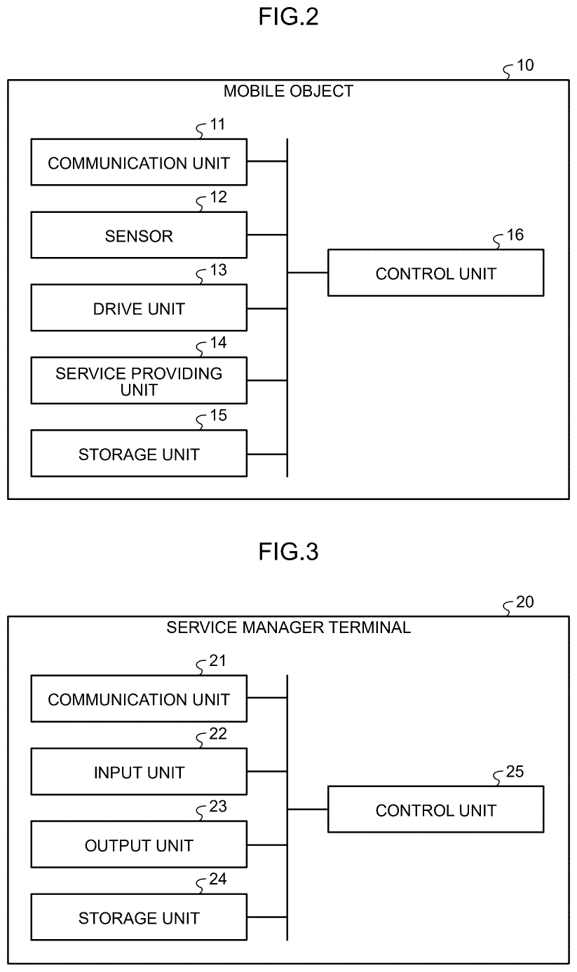

FIG. 2 is a functional block diagram of an example of the mobile object 10.

The mobile object 10 includes a communication unit 11, a sensor 12, a drive unit 13, a service providing unit 14, a storage unit 15, and a control unit 16. The communication unit 11, the sensor 12, the drive unit 13, the service providing unit 14, the storage unit 15, and the control unit 16 are communicably connected to each other via a bus or the like.

The communication unit 11 is an interface that communicates with the remote control terminal 30, the information processing apparatus 40, the remote control terminal 30, and the like via the network NW or the like.

The sensor 12 is a sensor that acquires a traveling environment of the mobile object 10. The traveling environment is, for example, observation information of the mobile object 10 or surrounding information of the mobile object 10. The sensor 12 is, for example, an internal sensor or an external sensor.

The internal sensor is a sensor that observes observation information. The observation information includes at least position information of the mobile object 10. The position information may be a relative position or an absolute position. In the present embodiment, a mode in which the position information is an absolute position represented by latitude and longitude will be described as an example. The internal sensor includes, for example, a position sensor (a global navigation satellite system (GNSS) or a global positioning system (GPS)). In addition, the observation information may include speed, acceleration, and the like. In this case, the internal sensor further includes, for example, an inertial measurement unit (IMU), an acceleration sensor, a speed sensor, a rotary encoder, or the like.

The external sensor observes surrounding information of the mobile object 10. The external sensor may be mounted on the mobile object 10 or may be mounted outside the mobile object 10. The outside of the mobile object 10 is, for example, another mobile object 10 other than the mobile object 10, an external device, or the like. Hereinafter, another mobile object 10 other than the mobile object 10 may be referred to as another mobile object.

The surrounding information is information indicating a situation around the mobile object 10. The surroundings of the mobile object 10 are areas within a predetermined range from the mobile object 10. This range is an observable range of the external sensor. This range may be set in advance.

The surrounding information is, for example, at least one of a captured image and distance information of the surroundings of the mobile object 10. The captured image is captured image data obtained by capturing an image. Hereinafter, the captured image data will be simply referred to as a captured image. The distance information is information indicating a distance from the mobile object 10.

The external sensor is, for example, an image capturing device that obtains a captured image by capturing an image, a distance sensor, or the like. The distance sensor is, for example, a millimeter wave radar, a laser sensor, a distance image sensor, or the like. The captured image is digital image data in which a pixel value is defined for each pixel, a depth map in which a distance from the sensor 12 is defined for each pixel, or the like. The laser sensor is, for example, a two-dimensional laser imaging detection and ranging (LiDAR) sensor installed in parallel with a horizontal plane or a three-dimensional LiDAR sensor.

The drive unit 13 is a device that is mounted on the mobile object 10 and drives the mobile object 10 in relation to its movement. The drive unit 13 is, for example, an engine, a motor, wheels, or the like. The drive unit 13 is driven under the control of the control unit 16. For example, the control unit 16 determines a surrounding situation based on the information or the like obtained from the sensor 12, and controls an accelerating amount, a braking amount, a steering angle, and the like. For example, the control unit 16 controls the drive unit 13 of the mobile object 10 such that the mobile object 10 autonomously moves according to a predetermined route within the predetermined area D.

The service providing unit 14 is hardware for providing a service. For example, in a case where the service provided by the mobile object 10 is a cargo conveyance service, the service providing unit 14 is a locker for placing cargo.

The storage unit 15 stores various types of data. The storage unit 15 is, for example, a semiconductor memory element such as a random access memory (RAM) or a flash memory, a hard disk, an optical disk, or the like. Note that the storage unit 15 may be a storage device provided outside the mobile object 10. Furthermore, the storage unit 15 may be a storage medium in which programs and various types of information downloaded via a LAN, the Internet, or the like are stored or temporarily stored.

In the present embodiment, the storage unit 15 stores a basic program for autonomous movement. The control unit 16 of the mobile object 10 executes control such as autonomous movement using the basic program stored in the storage unit 15. In addition, the storage unit 15 stores service information for the mobile object 10 to execute a service. For example, in a case where the service is a cargo delivery service, the service information includes information such as a cargo pickup location and a cargo delivery destination. The control unit 16 of the mobile object 10 controls the service providing unit 14, the drive unit 13, etc. so as to execute the service using the service information stored in the storage unit 15.

The control unit 16 is a computer that executes information processing in the mobile object 10. The control unit 16 is realized by one or more processors. The control unit 16 may be realized by causing a processor such as a central processing unit (CPU) to execute a program, that is, by software. It may be realized by a processor such as a dedicated IC, that is, by hardware. It may be realized by using software and hardware in combination. At least one of the one or more functional units included in the control unit 16 may be mounted on an external information processing apparatus communicably connected to the mobile object 10 via the network NW or the like.

The control unit 16 controls the drive unit 13 such that the mobile object 10 autonomously moves.

For example, the control unit 16 controls the drive unit 13 to autonomously move along a route represented by route information within the predetermined area D by using the captured image, the position information of the mobile object 10, and the like acquired by the sensor 12. The route along which the mobile object 10 autonomously moves is defined in advance, for example, in mobile object management information managed by the information processing apparatus 40, which will be described later, and the route and map information of a real space including the route are stored in advance in the storage unit 15 of the mobile object 10. The control unit 16 controls the drive unit 13 such that the mobile object 10 travels along the route using the map information, the information regarding the route, the position information detected by the sensor 12, the captured image acquired by the sensor 12, and the like. The mobile object 10 autonomously travels along the route under the control of the drive unit 13 by the control unit 16. Furthermore, the control unit 16 controls the service providing unit 14 based on the service information stored in the storage unit 15, thereby providing a service.

Furthermore, in a case where the control unit 16 detects a situation requiring remote control, the control unit 16 transmits remote control request information to the information processing apparatus 40.

The situation requiring remote control is, for example, a situation in which it is difficult for the mobile object 10 to move autonomously. The control unit 16 may detect a situation requiring remote control based on the detection result from the sensor 12, the driving state of the drive unit 13, and the providing state of the service providing unit 14. Then, in a case where a situation requiring remote control is detected, the control unit 16 transmits remote control request information to the information processing apparatus 40.

The remote control request information includes a moving object identifier (ID) of the mobile object 10, position information of the mobile object 10, and request content information.

The mobile object ID is identification information of the mobile object 10. The position information of the mobile object 10 is information indicating a position of the mobile object 10. The position information of the mobile object 10 is represented by, for example, the latitude and longitude of the mobile object 10. Furthermore, the position information of the mobile object 10 may be area identification information of the area D where the mobile object 10 currently exists. Furthermore, the position information of the mobile object 10 may be information capable of identifying traveling rules such as a traveling speed defined for the area D where the mobile object 10 travels.

The request content information is information indicating the content of the remote control request. For example, the request content information includes specific details of situations in which autonomous movement is difficult, information capable of identifying traveling rules such as a traveling speed defined for the area D where the mobile object 10 travels, information that can be used by the information processing apparatus 40 to allocate a remote operator, and the like.

Examples of the information that can be used by the information processing apparatus 40 to allocate a remote operator include status information of the mobile object 10, a service status of the mobile object 10, a service delay status of the mobile object 10, and information regarding the content of remote control to be performed in response to a remote request.

The status information of the mobile object 10 is, for example, information indicating a remaining state of a battery that drives the mobile object 10, whether or not cargo is loaded on the mobile object 10, and the like. In a case where the service provided by the mobile object 10 is conveyance of cargo, the service status of the mobile object 10 is, for example, information indicating whether the mobile object 10 is moving to a delivery destination, moving to a pickup location, or forwarding. In a case where the service provided by the mobile object 10 is conveyance of cargo, the service delay status of the mobile object 10 is, for example, information indicating spare, on time, or delayed, a delay time, and the like. The information regarding the content of remote control to be performed in response to the remote request is, for example, information indicating obstacle avoidance, departure determination, and the like.

The control unit 16 drives and controls the drive unit 13, the service providing unit 14, etc. in accordance with remote control by the remote control terminal 30 operated by an execution operator allocated by the information processing apparatus 40 to be described later as a remote operator Q who remotely controls the mobile object 10 among the remote operators Q. In detail, the control unit 16 drives and controls the drive unit 13, the service providing unit 14, etc. in response to a command regarding remote control received from the remote control terminal 30. With this control, the mobile object 10 is remotely controlled by the remote control terminal 30 operated by the remote operator Q.

FIG. 3 is a functional block diagram of an example of the service manager terminal 20.

The service manager terminal 20 includes a communication unit 21, an input unit 22, an output unit 23, a storage unit 24, and a control unit 25. The communication unit 21, the input unit 22, the output unit 23, the storage unit 24, and the control unit 25 are communicably connected to each other via a bus or the like.

The communication unit 21 is a communication interface that communicates with the mobile object 10, the remote control terminal 30, and the information processing apparatus 40 via the network NW or the like. For example, the communication unit 21 transmits information regarding the service such as service specifications to the information processing apparatus 40. In addition, the communication unit 21 transmits a service manager-requested condition of the service manager P to the information processing apparatus 40. The service manager-requested condition will be described in detail later. Furthermore, the communication unit 21 transmits information regarding the service to the mobile object 10. Furthermore, the communication unit 21 communicates with the remote control terminal 30 operated by the remote operator Q to receive inquiry information and the like regarding remote control from the remote operator Q. Furthermore, the communication unit 21 communicates various types of information with an external device.

The input unit 22 receives various operations performed by the service manager P. The input unit 22 is, for example, a keyboard, a pointing device such as a mouse, a microphone, or the like. The output unit 23 outputs various types of information. The output unit 23 is a display that displays various types of information, a speaker that outputs various types of sound, or the like. Note that the input unit 22 and the output unit 23 may be integrally configured as a touch panel. Furthermore, the input unit 22 and the output unit 23 may be configured separately from the service manager terminal 20. In this case, the input unit 22 and the output unit 23 may be communicably connected to the service manager terminal 20.

The storage unit 24 stores various types of data. The storage unit 24 is, for example, a semiconductor memory element such as a RAM or a flash memory, a hard disk, an optical disk, or the like. Note that the storage unit 24 may be a storage device provided outside the service manager terminal 20. Furthermore, the storage unit 24 may be a storage medium in which programs and various types of information downloaded via a local area network (LAN), the Internet, or the like are stored or temporarily stored. In the present embodiment, the storage unit 24 stores, for example, various types of information such as information required for creating service specifications.

The control unit 25 is a computer that executes information processing in the service manager terminal 20. The control unit 25 may be realized by causing a processor such as a CPU to execute a program, that is, by software. It may be realized by a processor such as a dedicated IC, that is, by hardware. The storage unit 15 may be realized by using software and hardware in combination. At least one of the one or more functional units included in the control unit 25 may be mounted on an external information processing apparatus communicably connected to the service manager terminal 20 via the network NW or the like.

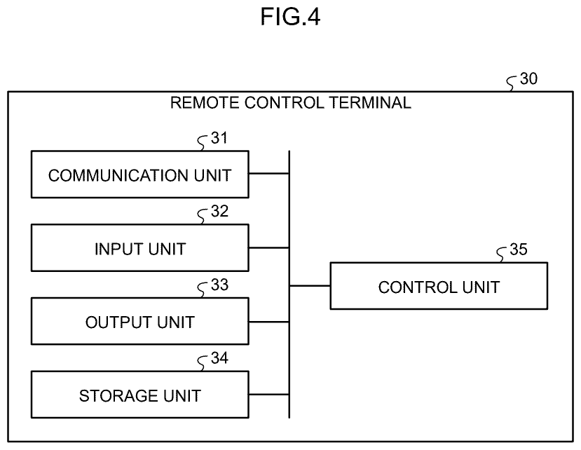

FIG. 4 is a functional block diagram of an example of the remote control terminal 30.

The remote control terminal 30 includes a communication unit 31, an input unit 32, an output unit 33, a storage unit 34, and a control unit 35. The communication unit 31, the input unit 32, the output unit 33, the storage unit 34, and the control unit 35 are communicably connected to each other via a bus or the like.

The communication unit 31 is a communication interface that communicates with the mobile object 10, the remote control terminal 30, and the information processing apparatus 40 via the network NW or the like. For example, the communication unit 31 receives remote control support request information in response to the remote control request information from the mobile object 10 from the information processing apparatus 40 via the network NW. Furthermore, the communication unit 31 transmits information regarding the remote operator Q to the information processing apparatus 40. Furthermore, the communication unit 31 transmits a command regarding remote control to the mobile object 10 that is a remote control target. Furthermore, the communication unit 31 communicates various types of information with an external device.

The input unit 32 receives various operations performed by the remote operator Q. For example, the input unit 32 receives a command input by the remote operator Q to remotely control the mobile object 10. The input unit 32 is, for example, a keyboard, a pointing device such as a mouse, a microphone, a handle, a joystick, an accelerator, a brake, a touch panel, or the like.

The output unit 33 outputs various types of information. For example, the output unit 33 outputs captured image information or the like of the mobile object 10 when the mobile object 10 that is a remote control target is remotely controlled. The output unit 33 is a display that displays various types of information, a speaker that outputs various types of sound, or the like. Note that the input unit 32 and the output unit 33 may be integrally configured as a touch panel. Furthermore, the input unit 32 and the output unit 33 may be configured separately from the remote control terminal 30. In this case, the input unit 32 and the output unit 33 may be communicably connected to the remote control terminal 30.

The storage unit 34 stores various types of data. The storage unit 34 is, for example, a semiconductor memory element such as a RAM or a flash memory, a hard disk, an optical disk, or the like. Note that the storage unit 34 may be a storage device provided outside the remote control terminal 30. Furthermore, the storage unit 34 may be a storage medium in which programs and various types of information downloaded via a LAN, the Internet, or the like are stored or temporarily stored.

In the present embodiment, the storage unit 34 stores, for example, a remote control application or the like. The remote control application is software for providing a function of receiving remote control support request information from the information processing apparatus 40, a function of executing remote control on the mobile object 10, and the like. The remote control application operates, for example, online with the information processing apparatus 40. Note that the remote control application may be configured to operate offline with respect to the information processing apparatus 40. The remote control application may be configured to be downloaded to the remote control terminal 30, or may be configured to implement the above-described functions on a browser without being downloaded.

The control unit 35 is a computer that executes information processing in the remote control terminal 30. The control unit 35 may be realized by causing a processor such as a CPU to execute a program, that is, by software. It may be realized by a processor such as a dedicated IC, that is, by hardware. The control unit 35 may be realized by using software and hardware in combination. At least one of the one or more functional units included in the control unit 35 may be mounted on an external information processing apparatus communicably connected to the service manager terminal 20 via the network NW or the like.

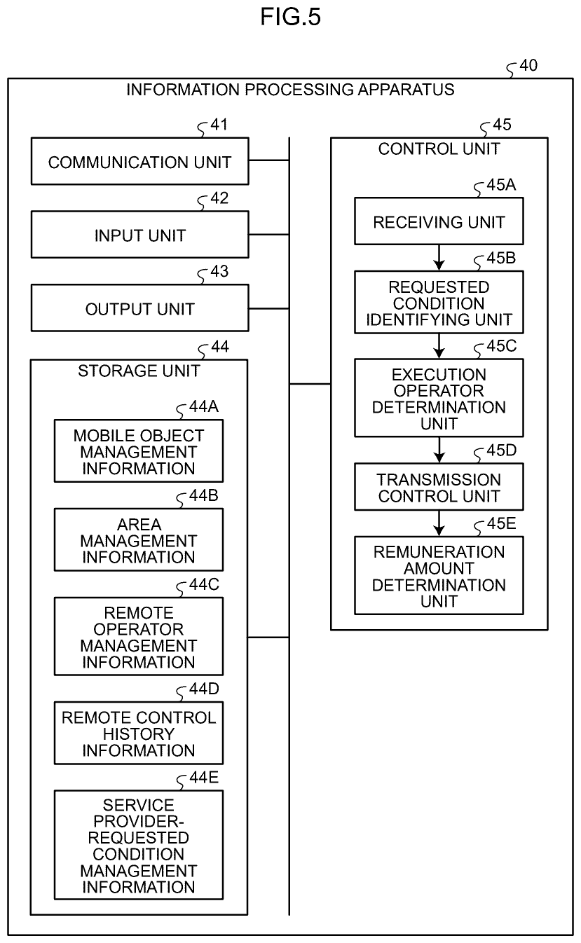

FIG. 5 is a functional block diagram of the information processing apparatus 40.

The information processing apparatus 40 includes a communication unit 41, an input unit 42, an output unit 43, a storage unit 44, and a control unit 45. The communication unit 41, the input unit 42, the output unit 43, the storage unit 44, and the control unit 45 are communicably connected to each other via a bus or the like.

The communication unit 41 is a communication interface that communicates with the mobile object 10, the service manager terminal 20, and the remote control terminal 30.

The input unit 42 receives various operations performed by a user. For example, the input unit 42 is a keyboard, a pointing device such as a mouse, a microphone, or the like. The output unit 43 outputs various types of information. For example, the output unit 43 is a display that displays various types of information, a speaker that outputs various types of sound, or the like. Note that the input unit 42 and the output unit 43 may be integrally configured as a touch panel.

The storage unit 44 stores various types of information. The storage unit 44 is, for example, a semiconductor memory element such as a RAM or a flash memory, a hard disk, an optical disk, or the like. Note that the storage unit 44 may be a storage device provided outside the information processing apparatus 40. Furthermore, the storage unit 44 may be a storage medium in which programs and various types of information downloaded via a LAN, the Internet, or the like are stored or temporarily stored.

In the present embodiment, the storage unit 44 stores mobile object management information 44A, area management information 44B, remote operator management information 44C, remote control history information 44D, service provider-requested condition management information 44E, and the like.

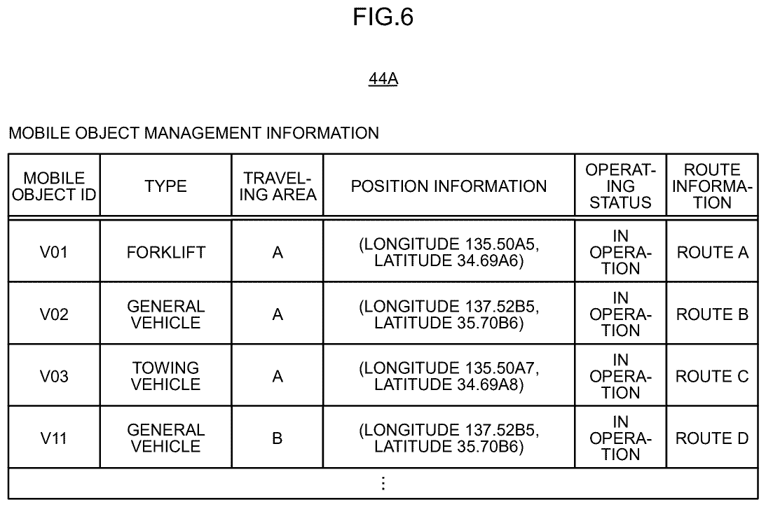

FIG. 6 is a schematic diagram illustrating an example of a data configuration of the mobile object management information 44A. The mobile object management information 44A is a database for managing information about each of the plurality of mobile objects 10 included in the remote control system 1, which are management targets of the information processing apparatus 40. The data format of the mobile object management information 44A is not limited to the database.

The mobile object management information 44A is a database in which a mobile object ID, a type, a traveling area, position information, an operating status, and route information are associated with each other. The mobile object ID is identification information of the mobile object 10. The type is a type of the mobile object 10. The traveling area is an area D where the mobile object 10 is traveling. The position information is current position information of the mobile object 10, and is represented by, for example, latitude and longitude. The operating status is information indicating whether or not the mobile object 10 is in operation. The route information is information indicating a route along which the mobile object 10 travels.

The dynamically changed information such as the position information and the operating status in the mobile object management information 44A is received from the mobile object 10 periodically or when a predetermined event occurs, and is updated by the control unit 45 of the information processing apparatus 40. In addition, the static information such as the mobile object ID in the mobile object management information 44A is not basically updated, but may be appropriately changed in response to a user's instruction made by operating the input unit 42, a request from the service manager terminal 20, or the like.

Note that the information stored in the mobile object management information 44A is not limited thereto. For example, the mobile object management information 44A may be a database in which at least one of a remaining battery amount of the mobile object 10, a service content performed by the mobile object 10, a status of the service performed by the mobile object 10, a failure status of the mobile object 10, a communication status of the mobile object 10, a hardware configuration of the mobile object 10, and a software configuration of the mobile object 10 is further associated with the mobile object ID of each mobile object 10.

The service content is, for example, information indicating conveyance of goods or the like performed by the mobile object 10. The service status is, for example, information indicating whether or not there is a delay in the service performed by the mobile object 10. The failure status is, for example, information indicating whether or not there is a failure in the mobile object 10. The communication status of the mobile object 10 is, for example, information indicating whether the communication of the mobile object 10 is good, poor, or cut off, and the like. The hardware configuration of the mobile object 10 is, for example, information indicating the arrangement of cameras mounted on the mobile object 10, whether the driving source is electric or engine-powered, and the like. The software configuration of the mobile object 10 is type and version information of software installed in the mobile object 10, and the like.

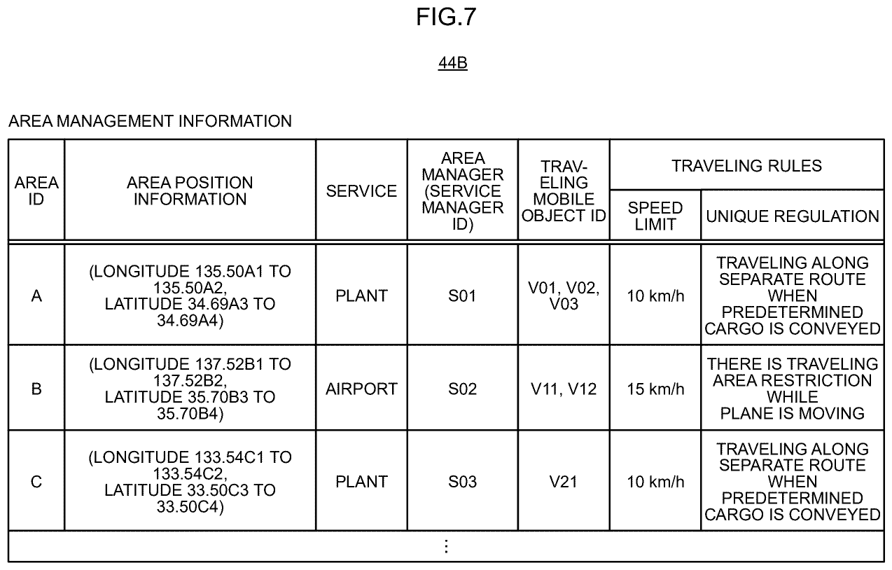

FIG. 7 is a schematic diagram illustrating an example of a data configuration of the area management information 44B. The area management information 44B is a database for managing information regarding an area D in which the mobile object 10 executes a service and for managing information regarding traveling rules of the mobile object 10 at least in the area D. The data format of the area management information 44B is not limited to the database.

The area management information 44B is a database in which an area ID, area position information, a service, an area manager, a traveling mobile object ID, and traveling rules are associated with each other.

The area ID is identification information of the area D. The area position information is information indicating a position, a size, and a range of the area D in the real space. The area manager is information indicating a manager of the area D, and a service manager ID, which is identification information of any service manager P, is registered. The traveling mobile object ID is identification information of the mobile object 10 that is traveling in the area D identified by the area ID.

The traveling rules are traveling rules defined for the area D identified by the area ID. The traveling rules are, for example, a speed limit in the area D, a unique regulation for each area D, and the like. In addition, the traveling rules may further include at least one of information indicating which mobile object 10 can or cannot travel in the area D identified by the area ID, information indicating which mobile object 10 can or cannot stop in the area D, information indicating a location or a condition under which a temporary stop is required in the area D, and a speed limit for each specific time zone or for each specific mobile object 10 in the area D.

That is, the area management information 44B manages areas D by area D for which the traveling rules are the same as those defined for an area where a mobile object 10 is to travel in the real space. As illustrated in FIG. 1, in the present embodiment, a mode in which the area D is a substantially rectangular area will be described as an example. However, the shape of the area D is not limited to the rectangular shape, and may be a square shape, a circular shape, or another shape. In addition, the area D only needs to be an area for which the traveling rules are the same as those in the real space, and may be an area of a dispersed enclave.

In addition, the service range and the traveling rules may be different for each service or for each mobile object 10. In this case, the area D may be an area divided for at least one of each service and each mobile object 10. In this case, the area position information may include information indicating the type of the service and the type of the mobile object 10 together with information indicating the position, the size, and the range of the area D in the real space. Further, some of the plurality of areas D may overlap each other.

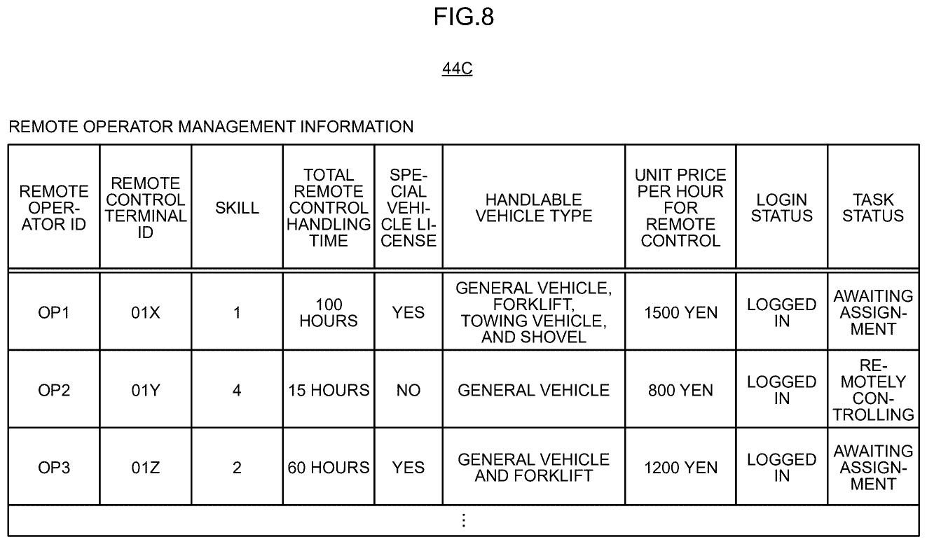

FIG. 8 is a schematic diagram illustrating an example of a data configuration of the remote operator management information 44C. The remote operator management information 44C is a database for managing remote operators Q. The data format of the remote operator management information 44C is not limited to the database.

The remote operator management information 44C is a database in which a remote operator ID, a remote control terminal ID, a skill, a total remote control handling time, a handlable vehicle type, a unit price per remote control time, a login status, and a task status are associated with each another.

The remote operator ID is identification information of the remote operator Q. The respective remote operator IDs of all the remote operators Q using the remote control system 1 are registered in the remote operator management information 44C.

The remote control terminal ID is identification information of the remote control terminal 30 used by the remote operator Q. The skill is information indicating an ability related to the remote control of the remote operator Q. In FIG. 8, the skill is expressed on a five-level scale from 1 to 5, where a smaller numerical value indicates a higher level of ability (skill). For example, the skill is determined depending on the length of time required for handling the remote control. In addition, the skill may be determined depending on the result of the test for measuring the remote control skill. In addition, the skill may be determined depending on the experience value of remote control. The experience value is represented by a total remote control handling time, a total number of times, or the like.

The total remote control handling time is a total time for which the remote operator Q handles the remote control of the mobile object 10. The special vehicle license is information indicating whether or not the remote operator Q has a driver's license for a special vehicle. The handleable vehicle type is information indicating the vehicle type of the mobile object 10 that can be handled by the remote operator Q. The unit price per hour for remote control is information indicating a unit price (labor cost) per hour for the remote operator Q to operate the mobile object 10 to be remotely controlled by the remote operator Q. The login status is information indicating whether or not the remote operator Q is logged in to the remote control system 1. The task status is information indicating whether the remote operator Q is remotely controlling the mobile object 10 or awaiting allocation (awaiting assignment).

The dynamically changed information such as the total remote control handling time, the login status, and the task status in the remote operator management information 44C is received from the mobile object 10 periodically or when a predetermined event occurs, and is updated by the control unit 45 of the information processing apparatus 40. In addition, the skill, the special vehicle license, and the like are appropriately updated when being updated.

Note that the information stored in the remote operator management information 44C is not limited thereto. For example, the remote operator management information 44C may further include information indicating a total handling time or a total number of times for each remote control task, a hardware configuration of the remote control terminal 30, a software configuration of the remote control terminal 30, whether or not an optional function is used, and the like.

Examples of the remote control task include obstacle avoidance, departure confirmation, and the like. The hardware configuration of the remote control terminal 30 is, for example, a configuration of a steering wheel, a brake, an accelerator, a display, or the like. The software configuration of the remote control terminal 30 is information indicating the type, version, and the like of software installed in the remote control terminal 30. Whether or not the optional function is used is, for example, information indicating whether or not a driving assistance function using artificial intelligence (AI) is used.

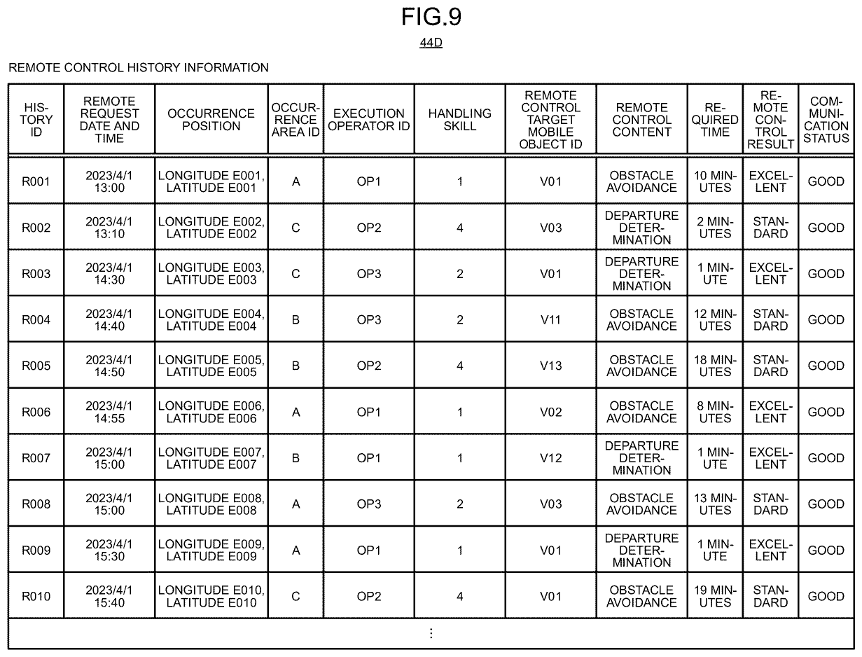

FIG. 9 is a schematic diagram of an example of a data configuration of the remote control history information 44D. The remote control history information 44D is a database for managing history information on the remote control of the mobile object 10 performed by the remote operator Q. The data configuration of the remote control history information 44D is not limited to the database.

The remote control history information 44D is a database in which a history ID, a remote request date and time, an occurrence position, an occurrence area ID, an execution operator ID, a handling skill, a remote control target mobile object ID, a remote control content, a required time, a remote control result, and a communication status are associated with each other.

The history ID is history identification information. The occurrence position is information indicating a position of the mobile object 10 when the remote control request information is transmitted. The occurrence area ID is identification information of the area D where the mobile object 10 exists when the remote control request information is transmitted. The execution operator ID is identification information of the remote operator Q who has executed the remote control of the mobile object 10. The handling skill is information indicating a skill of the remote operator Q when the remote control is handled. The remote control target mobile object ID is identification information of the mobile object 10 that is a remote control target. The remote control content is information indicating a content of the remote control. The required time is information indicating a time required for the remote control.

The remote control result is information indicating a result of the remote control. The remote control result may be, for example, a result evaluated according to a difference between an estimated required time and an actual required time for handling the remote control request information. For example, the control unit 45 may register a remote control result indicating “bad” when a subtraction result obtained by subtracting the actual required time from the estimated required time is a negative value, “standard” when the subtraction result is 0, or “excellent” when the subtraction result is a positive value. In addition, after handling the remote control request information, the control unit 45 may register a user's evaluation result as the remote control result. For example, the service manager P may check the content and the result of handling the remote control, and the control unit 45 may register the evaluation result obtained by evaluating the handling of the remote control as the remote control result.

The communication status is information indicating a communication status between the mobile object 10 when being remotely controlled and the remote control terminal 30 that is performing remote control.

Note that the following information may be further registered in the remote control history information 44D. For example, information regarding the remote control terminal 30 used for remote control, whether or not an optional function is used, a degree of fatigue of the remote operator Q during handling remote control, a surrounding situation of the mobile object 10 during handling remote control, and the like may be further registered in the remote control history information 44D. The information regarding the remote control terminal 30 is, for example, a hardware configuration of the remote control terminal 30, a software configuration of the remote control terminal 30, or the like. Whether or not the optional function is used is, for example, information indicating whether or not a driving assistance function using AI is used. The degree of fatigue of the remote operator Q during handling remote control is represented by, for example, a time required for handling the remote control up to that point. The surrounding situation of the mobile object 10 during handling remote control is, for example, information indicating whether or not there are obstacles or other mobile objects 10 around the mobile object 10, the number of other mobile objects 10, weather, a road width, and the like.

The service provider-requested condition management information 44E will be described later.

Referring back to FIG. 5, the description will be continued.

The control unit 45 includes a receiving unit 45A, a requested condition identifying unit 45B, an execution operator determination unit 45C, a transmission control unit 45D, and a remuneration amount determination unit 45E.

The receiving unit 45A, the requested condition identifying unit 45B, the execution operator determination unit 45C, the transmission control unit 45D, and the remuneration amount determination unit 45E are realized by, for example, one or more processors. For example, each of the above-described units may be realized by causing a processor such as a CPU to execute a program, that is, by software. Each of the above-described units may be realized by a processor such as a dedicated integrated circuit (IC), that is, by hardware. Each of the above-described units may be realized by using software and hardware in combination. In the case where a plurality of processors are used, each of the plurality of processors may realize one of the plurality of units, or may realize two or more of the plurality of units.

The processor realizes each of the plurality of units by reading and executing a program stored in a read only memory (ROM) or the like. Instead of storing the program in the ROM, the program may be directly incorporated into a circuit of the processor. In this case, the processor realizes each of the plurality of units by reading and executing the program incorporated in the circuit.

The receiving unit 45A receives remote control request information from the mobile object 10. The receiving unit 45A receives the remote control request information from the mobile object 10 via the communication unit 41.

The requested condition identifying unit 45B identifies a service manager-requested condition of the service manager P.

The service manager-requested condition is information indicating a condition requested by the service manager P regarding allocating a remote operator Q who remotely controls a mobile object 10. The service manager-requested condition is registered in the service provider-requested condition management information 44E, for example, in advance.

For example, the control unit 45 receives a service provider-requested condition from the service manager terminal 20 operated by the service manager P, and registers the service provider-requested condition in the service provider-requested condition management information 44E in advance. The requested condition identifying unit 45B identifies the service manager-requested condition by reading the service provider-requested condition management information 44E.

For example, the service manager-requested condition is information indicating that a remote operator Q having a remote control history for the area under the traveling rule corresponding to the traveling area of the mobile object 10 from which the remote control request information is transmitted is determined as the execution operator.

Note that the service manager-requested condition may be information indicating a condition requested by the service manager P regarding allocating a remote operator Q who remotely controls the mobile object 10, and is not limited to the mode in which it is set by the service manager P operating the service manager terminal 20. For example, the service manager-requested condition may be set in the service provider-requested condition management information 44E by an operator who manages the information processing apparatus 40 estimating the need of the service manager P. In addition, an operator who has received a physical media medium from the service manager P may operate the information processing apparatus 40 to set a service manager-requested condition recorded in the media medium in the service provider-requested condition management information 44E.

The execution operator is one of the plurality of remote operators Q registered in the remote control system 1, and is a remote operator Q who remotely controls the mobile object 10 from which the remote control request information is transmitted.

Based on the remote control request information received from the mobile object 10, the execution operator determination unit 45C determines a remote operator Q satisfying the service manager-requested condition of the service manager P as an execution operator who remotely controls the mobile object 10 from which the remote control request information is transmitted.

First, the execution operator determination unit 45C identifies an assignable remote operator Q. The execution operator determination unit 45C identifies, as the assignable remote operator Q, a remote operator Q identified by the remote operator ID corresponding to the login status “logged in” and the task status “awaiting assignment” indicating that the remote operator Q is awaiting allocation in the remote operator management information 44C.

Note that the execution operator determination unit 45C may identify an assignable remote operator Q based on other conditions.

For example, the execution operator determination unit 45C may identify, as the assignable remote operator Q, a remote operator Q who not only satisfies the above-described conditions for the login status and the task status but also satisfies an assignment condition designated in advance by the service manager P. The assignment condition designated in advance by the service manager P is, for example, that the unit price per hour for operation is 1000 yen or more, that the skill of the remote operator Q is 3 or more, or the like.

In addition, in a case where the operation time during which the remote operator Q can operate is determined, the execution operator determination unit 45C may identify a remote operator Q who is able to complete remote control within the determined operation time as the assignable remote operator Q. For example, it is assumed that the remote operator Q has 10 minutes as a remaining operation time. In this case, the execution operator determination unit 45C identifies a remote operator Q whose estimated time required for the remote control indicated by the remote control request information is less than 10 minutes as the assignable remote operator Q. In addition, for example, it is assumed that the remote operator Q has 15 minutes as a remaining operation time. In this case, the execution operator determination unit 45C does not identify a remote operator Q whose estimated required time for the remote control indicated by the remote control request information is 15 minutes or more, but identifies a remote operator Q whose estimated time required for the remote control indicated by the remote control request information is less than 15 minutes as the assignable remote operator Q.

The execution operator determination unit 45C identifies a remote operator Q satisfying the service manager-requested condition identified by the requested condition identifying unit 45B, among the identified remote operators Q, as the execution operator.

For example, as described above, it is assumed that the service manager-requested condition is information indicating that a remote operator Q having a remote control history for the area under the traveling rule corresponding to the traveling area of the mobile object 10 from which the remote control request information is transmitted is determined as the execution operator. In this case, the execution operator determination unit 45C determines, as the execution operator, a remote operator Q having a remote control history for the area D under the traveling rule corresponding to the traveling area of the mobile object 10 from which the remote control request information is transmitted. The area under the traveling rule corresponding to the traveling area refers to an area under the traveling rule that matches or is similar to the traveling rule of the traveling area.

As described above, in the present embodiment, the traveling rule is defined for each area D. Therefore, the execution operator determination unit 45C identifies identification information of the traveling area corresponding to the mobile object ID included in the remote control request information from the mobile object management information 44A. Then, the execution operator determination unit 45C identifies, from the remote control history information 44D, an occurrence area ID that matches the identified identification information of the traveling area. Then, the execution operator determination unit 45C determines a remote operator Q identified by an execution operator ID corresponding to the identified occurrence area ID as the execution operator who remotely controls the mobile object 10 from which the remote control request information is transmitted.

Specifically, the execution operator determination unit 45C determines whether or not there is a remote operator Q having experience in remotely controlling a mobile object 10 existing in an area D of the same traveling rule as the traveling area of the mobile object 10 from which the remote control request information is transmitted, among the remote operators Q identified as being assignable.

In this case, the execution operator determination unit 45C determines whether or not there is a remote operator ID for which the area ID of the traveling area of the mobile object 10 from which the remote control request information is transmitted is registered as the occurrence area ID, among the remote operator IDs of the remote operators Q identified as being assignable, in the remote control history information 44D.

For example, it is assumed that the execution operator IDs “OP1” and “OP3” are identified as the remote operator IDs of the assignable remote operators Q. In addition, it is assumed that the area ID of the traveling area of the mobile object 10 from which the remote control request information is transmitted is “C”. In this case, the execution operator determination unit 45C determines a remote operator Q identified by the execution operator ID “OP3”, which is associated with “C” as the occurrence area ID, among the execution operator IDs “OP1” and “OP3”, as the execution operator for the mobile object 10 from which the remote control request is transmitted.

Note that the execution operator determination unit 45C may determine a mobile object 10 existing in an area D that is the same as the area D where the mobile object 10 from which the remote control request information is transmitted is located as a mobile object 10 existing in an area D of the same traveling rule as the mobile object 10 from which the remote control request information is transmitted.

For example, it is assumed that remote control request information is received from the mobile object 10 existing in the area D of the area ID “A”. In this case, the execution operator determination unit 45C determines, as the execution operator, a remote operator Q having experience in remotely controlling another mobile object 10 existing in the area D of the area ID “A” among the remote operators Q identified as being assignable.

In this case, the determined execution operator is a remote operator Q having experience in remotely controlling a mobile object 10 located in the same area D as the mobile object 10 from which the remote control request information is transmitted. Therefore, in this case, the execution operator determination unit 45C can determine a remote operator Q who already understands the traffic rules and surrounding situations of the area D as the execution operator. In addition, the execution operator can handle the remote control safely and quickly.

In the remote control history information 44D, the remote control history referred to by the execution operator determination unit 45C when determining an execution operator is preferably a more recent remote control history. In addition, when there is a change in traffic rule for the area D, the execution operator determination unit 45C preferably determines an execution operator using the remote control history of the schedule after the change in traffic rule in the remote control history information 44D. In addition, the execution operator determination unit 45C preferably determines an execution operator using a similar remote control history such as a time zone in which the surrounding situation is similar to that of the mobile object 10 from which the remote control request information is transmitted and the number of surrounding mobile objects 10 in the remote control history information 44D.

In addition, the execution operator determination unit 45C may determine a mobile object 10 existing in an area D managed by the same area manager as the area D where the mobile object 10 from which the remote control request information is transmitted is located as a mobile object 10 existing in an area D of the same traveling rule as the mobile object 10 from which the remote control request information is transmitted.

For example, it is assumed that remote control request information is received from a mobile object 10 in the area D of the area ID “A” managed by the area manager ID “S01”. In addition, it is assumed that the service manager P identified by the area manager ID “S01” manages the areas D of the area IDs “A” and “D”, respectively. In this case, the execution operator determination unit 45C may identify a remote operator Q identified by the execution operator ID with the areas D of the area IDs “A” and “D”, respectively, as the occurrence area IDs from the remote control history information 44D, and determine the identified remote operator Q as the execution operator in preference to the other remote operators Q.

In addition, the execution operator determination unit 45C may determine a mobile object 10 existing in an area D where the same service is performed as the area D where the mobile object 10 from which the remote control request information is transmitted is located as a mobile object 10 existing in an area D of the same traveling rule as the mobile object 10 from which the remote control request information is transmitted.

For example, it is assumed that remote control request information is received from a mobile object 10 located in the area D of the area ID “A”. The service provided with the area ID “A” is the same as the service provided with the area ID “C” (see FIG. 7). In this case, the execution operator determination unit 45C may identify a remote operator Q identified by the execution operator ID with the areas D of the area IDs “A” and “C”, respectively, as the occurrence area IDs from the remote control history information 44D, and determine the identified remote operator Q as the execution operator in preference to the other remote operators Q.

In a case where a plurality of remote operators Q are determined as execution operators, the execution operator determination unit 45C may further narrow down the conditions and specify one remote operator Q as the execution operator.

For example, the execution operator determination unit 45C may specify, as the execution operator, one remote operator Q having the largest number of matches with the time at which the remote control request information is received, the partial area obtained by further subdividing the area D where the mobile object 10 from which the remote control request information is transmitted exists, and the vehicle type of the mobile object 10, among the plurality of remote operators Q determined as execution operators.

In addition, the execution operator determination unit 45C may narrow down the plurality of remote operators Q determined as the execution operators using a condition designated in advance by the service manager P, such as a skill of a remote operator Q or a remuneration amount for a remote operator Q represented by the unit price per hour for operation, or the like, and determine one remote operator Q as the execution operator.

For example, it is assumed that the condition is that the remote operator Q has high skill. In this case, among the plurality of remote operators Q determined as execution operators, the execution operator determination unit 45C determines one remote operator Q having the highest skill as the execution operator.

In addition, for example, it is assumed that the condition is that the unit price per hour for operation is 1000 yen or more. In this case, among the plurality of remote operators Q determined as execution operators, the execution operator determination unit 45C may determine a remote operator Q whose unit price per hour for remote control is 1000 yen or more, who is registered in the remote operator management information 44C, as the execution operator.

When the execution operator determination unit 45C fails to determine a remote operator Q satisfying the service manager-requested condition of the service manager P, the execution operator determination unit 45C may determine a remote operator Q for the remote control request information as the execution operator using another service manager-requested condition. The another service manager-requested condition may be arbitrary.

The transmission control unit 45D transmits remote control support request information to the remote control terminal 30 operated by the determined execution operator.

The remote control support request information may be information including at least one of the mobile object ID of the mobile object 10 that is a remote control target, the request content information included in the remote control request information received from the mobile object 10, the type corresponding to the mobile object ID in the mobile object management information 44A, the traveling area, the position information, the operating status, and the route information. In addition, the remote support request information may include a traveling rule corresponding to the area ID of the traveling area of the mobile object 10.

The remote operator Q operating the remote control terminal 30 that has received the remote control support request information remotely controls the mobile object 10 by operating the input unit 32 of the remote control terminal 30, thereby executing remote control corresponding to the remote control request information.

The remuneration amount determination unit 45E determines a remuneration amount for the execution operator according to at least one of the remote control request information, the status of determination made by the execution operator, and the status of remote control performed by the execution operator. The remuneration amount determination unit 45E will be described in detail later.

Next, an example of a flow of information processing executed by the control unit 45 of the information processing apparatus 40 according to the present embodiment will be described.

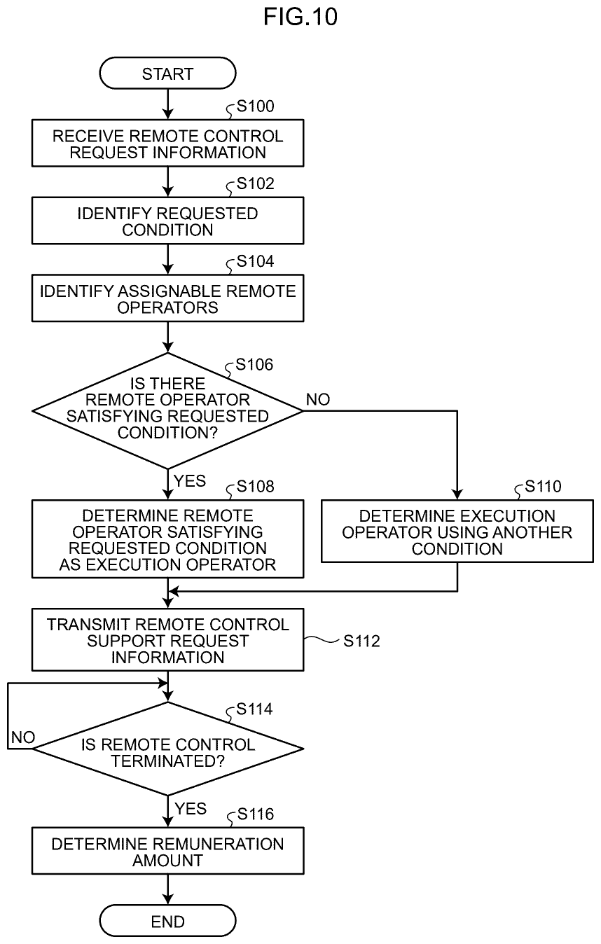

FIG. 10 is a flowchart illustrating an example of a flow of information processing executed by the control unit 45 of the information processing apparatus 40 according to the present embodiment.

The receiving unit 45A receives remote control request information from the mobile object 10 (step S100).

The requested condition identifying unit 45B identifies a service manager-requested condition of the service manager P (step S102). As described above, in the present embodiment, for example, it is assumed that the service manager-requested condition is information indicating that a remote operator Q having a remote control history for the area under the traveling rule corresponding to the traveling area of the mobile object 10 from which the remote control request information is transmitted is determined as an execution operator satisfying the service manager-requested condition.

The execution operator determination unit 45C identifies assignable remote operators Q (step S104). Then, the execution operator determination unit 45C determines whether or not there is a remote operator Q satisfying the service manager-requested condition identified in step S102 among the remote operators Q identified in step S104 (step S106).

When it is determined that there is a remote operator Q satisfying the service manager-requested condition (step S106: Yes), the execution operator determination unit 45C determines the remote operator Q satisfying the service manager-requested condition as an execution operator (step S108).

On the other hand, when it is determined that there is no remote operator Q satisfying the service manager-requested condition (step S106: No), the execution operator determination unit 45C determines an execution operator using another condition for assignment (step S110).

The transmission control unit 45D transmits remote control support request information to the remote control terminal 30 operated by the execution operator determined in step S108 or step S110 (step S112).

The control unit 45 repeats a negative determination (step S114: No) until it is determined that the remote control of the mobile object 10 according to the remote control support request information transmitted in step S112 is terminated. For example, the control unit 45 executes the determination of step S114 by determining whether or not an end signal has been received from the remote control terminal 30 that has transmitted the remote control support request information in step S112. When an affirmative determination is made in step S114 (step S114: Yes), the processing proceeds to step S116.

In step S116, the remuneration amount determination unit 45E determines a remuneration amount for the execution operator according to at least one of the remote control request information, the status of determination made by the execution operator, and the status of remote control performed by the execution operator (step S116). Then, this routine ends.

As described above, the information processing method executed by the information processing apparatus 40 according to the present embodiment is an information processing method executed by the information processing apparatus 40 that communicates with the mobile object 10 that autonomously moves and can be remotely controlled, the service manager terminal 20 operated by the service manager P, and the remote control terminal 30 operated by the remote operator Q. The information processing method includes: a receiving step of receiving remote control request information from the mobile object 10; and an execution operator determination step of determining, based on the received remote control request information, a remote operator Q satisfying a service manager-requested condition representing a condition requested by the service manager P regarding allocating a remote operator Q who remotely controls the mobile object 10, as an execution operator who remotely controls the mobile object 10 from which the remote control request information is transmitted.

Therefore, the remote operator allocation method according to the present embodiment is capable of allocating a remote operator Q according to the need of the service manager P as an execution operator who remotely controls the mobile object 10.

Therefore, the information processing apparatus 40 according to the present embodiment can realize the allocation of the remote operator Q according to the need of the service manager P.

### First Modification

In the above-described embodiment, a mode in which the service manager-requested condition is information indicating that a remote operator Q having a remote control history for the area under the traveling rule corresponding to the traveling area of the mobile object 10 from which the remote control request information is transmitted is determined as the execution operator has been described as an example. However, the service manager-requested condition is not limited to the above-described condition.

For example, in a case where remote control request information is received or has been received multiple times from the same mobile object 10 within a predetermined range in terms of time or distance, the service manager-requested condition may be information indicating that the same remote operator Q is determined as the execution operator for the remote control request information multiple times.

That is, in a case where remote control request information is received or has been received from the same mobile object 10 multiple times within a predetermined range in terms of time or distance, the execution operator determination unit 45C may determine the same remote operator Q as the execution operator for the remote control request information received multiple times.

In this case, a remote operator Q who has the best understanding of the current status of the mobile object 10 from which the remote control request information is transmitted can be determined as the execution operator. Therefore, it is possible to allocate, as the execution operator, a remote operator Q satisfying the need of the service manager P who desires not to stop the service provided by the mobile object 10 as much as possible.

For example, it is assumed that the control unit 45 predicts in advance that remote control request information will be consecutively received from the same mobile object 10 within a predetermined period. This prediction processing may be performed using a known method. In this case, the execution operator determination unit 45C determines the same remote operator Q as the execution operator for the mobile object 10 from which the consecutively received remote control request information is transmitted.

Specifically, the execution operator determination unit 45C identifies a scheduled moving route of each of the plurality of mobile objects 10 managed by the remote control system 1 from the route information of the mobile object management information 44A. Then, based on information indicating an occurrence position for each remote reception date and time registered in the remote control history information 44D, the execution operator determination unit 45C identifies an area D where a mobile object 10 predicted to transmit remote control request information is located within the scheduled moving route of the mobile object 10. Then, the execution operator determination unit 45C calculates a predicted time at which remote control request information will occur for each of the identified areas D based on the traveling speed when the mobile object 10 travels along the scheduled moving route. Further, based on the calculated predicted time at which the remote control request information will occur for each area D, the execution operator determination unit 45C determines whether or not the remote control request information will consecutively occur within the predetermined period. When it is determined that remote control request information will consecutively occur within the predetermined period, the execution operator determination unit 45C may determine the same remote operator Q as the execution operator for the remote control request information that will consecutively occur within the predetermined period. Note that the execution operator determination unit 45C may determine which remote operator Q is to be allocated as the execution operator under any condition.

In addition, the execution operator determination unit 45C may determine the execution operator in a similar manner in a case where remote control request information has been consecutively received within a predetermined distance, instead of the predetermined period, from the same mobile object 10.

In this case, the execution operator determination unit 45C may use a predicted occurrence position at which the remote control request information occurs, instead of the predicted occurrence time at which the remote control request information occurs.

In a case where the number of times remote control request information consecutively occurs within the predetermined period exceeds a predetermined value, the execution operator determination unit 45C may determine, as the execution operator, a remote operator Q different from the remote operator Q determined at the stage where the number of times is smaller than the predetermined value. This processing reduces the likelihood that the remote operator Q will lose concentration due to the consecutive support of remote control, which impairs safety.

Note that, in a case where a cumulative time taken to handle remote control request information that consecutively occurs within the predetermined period, instead of the number of times the remote control request information occurs, exceeds a predetermined time, the execution operator determination unit 45C may determine, as the execution operator, a remote operator Q different from the remote operator Q determined at a stage where the cumulative time is shorter than the predetermined time. This processing reduces the likelihood that the remote operator Q will lose concentration due to the consecutive handling of remote control for a long period of time, which impairs safety.

In addition, in a case where remote control request information is consecutively received from the same mobile object 10 within a predetermined period or a predetermined distance, limited to a specific time zone and a specific area D, the execution operator determination unit 45C may preferentially determine the same remote operator Q as the execution operator for that mobile object 10.

Further, when remote control request information is consecutively received from the same mobile object 10 within a predetermined period or a predetermined distance in a situation where it is difficult to grasp the status of the mobile object 10 from which the remote control request information is transmitted, the execution operator determination unit 45C may preferentially determine the same remote operator Q as the execution operator for that mobile object 10. This is because, in a case where it is easy to grasp the status of the mobile object 10 from which the remote control request information is transmitted, even another remote operator Q can immediately grasp the status, and it is considered that there will be no large difference in remote control speed as compared with a case where the same remote operator Q is determined as the execution operator.

In addition, in a case where remote control request information is consecutively received within a predetermined period or within a predetermined distance from the same mobile object 10 in the area D where the status does not greatly change in a short period of time, the execution operator determination unit 45C may determine the same remote operator Q as the execution operator for that mobile object 10. This is because, in an area where the status greatly changes in a short period of time, even in a case where the same remote operator Q is determined as the execution operator, the status will greatly change from that in the previous remote control, and it is considered that the time required for grasping the status will be approximately the same regardless of whether the same remote operator Q or another remote operator Q is determined. This determination method is also preferable from the viewpoint of fairly determining a plurality of different remote operators Q as execution operators as much as possible.

In addition, in a case where remote control request information is consecutively received from the same mobile object 10 within a predetermined period or a predetermined distance, limited to a mobile object 10 in a specific vehicle type, the execution operator determination unit 45C may preferentially determine the same remote operator Q as the execution operator for that mobile object 10.

The camera arrangement, the camera performance, the performance of the obstacle detection sensor, and the like differ depending on the vehicle type of the mobile object 10. For this reason, it is considered that, even among mobile objects 10 that are in the same situation, there may exist a mobile object 10 of which the status is easy to grasp for the remote operator Q and a mobile object 10 of which the status is difficult to grasp for the remote operator Q. In the case of the mobile object 10 of which the status is easy to grasp, it is considered that, even in a case where a different remote operator Q is determined as the execution operator for that mobile object 10, the status can be grasped immediately, and there will be no great difference in remote control speed from that in a case where the same remote operator Q is determined as the execution operator for that mobile object 10. Therefore, when remote control request information is consecutively received from the same mobile object 10 within a predetermined period or a predetermined distance, limited to a mobile object 10 of which the status is difficult to grasp, the execution operator determination unit 45C may preferentially determine the same remote operator Q as the execution operator for that mobile object 10.

In a case where the remote control request information is consecutively received from the same mobile object 10 within the predetermined period or the predetermined distance, the execution operator determination unit 45C may transmit information indicating a period between the remote control request information received earlier and the remote control request information received later to the remote control terminal 30 operated by the determined remote operator Q. By transmitting the information indicating the period to the remote control terminal 30 operated by the execution operator, the remote operator Q who is the execution operator operating the remote control terminal 30 is placed in a state that facilitates preparation for later remote control request information.

In addition, the execution operator determination unit 45C may control the remote control terminal 30 of the execution operator such that, after handling earlier remote control request information, video data of the surroundings of the mobile object 10 that is a remote control target is continuously played back until later remote control request information is started. In this case, the remote operator Q who is the execution operator can continuously grasp the status of the mobile object 10 that is a remote control target, and can therefore quickly handle later remote control request information. In addition, by controlling the remote control terminal 30 so as to continuously play back the video data of the surroundings of the mobile object 10, the process of reconnecting the video communication is also unnecessary.

Furthermore, in this case, the remote operator Q who is the execution operator monitors video information connecting the earlier remote control request information and the later remote control request information. Therefore, the remuneration amount determination unit 45E may calculate a remuneration with an additional increase corresponding thereto.

In addition, the execution operator determination unit 45C may collectively notify the remote control terminal 30 of the remote operator Q who is the execution operator of the earlier remote control request information and the later remote control request information as one task. In this case, it is possible to provide the remote control request information in such a manner that the remote operator Q can recognize that the remote operator Q will handle the remote control request information transmitted consecutively from the same mobile object 10, thereby making it easier for the remote operator Q to prepare for handling remote control request information.

In addition, when earlier remote control request information occurs, the execution operator determination unit 45C may notify the remote control terminal 30 of the remote operator Q who has been determined as the execution operator that the remote operator Q also needs to handle later remote control request information.

In addition, before and after the execution operator has completed handling the earlier remote control request information, the execution operator determination unit 45C may notify the remote control terminal 30 operated by the remote operator Q who is the execution operator that the remote operator Q also needs to handle later remote control request information.

In addition, the execution operator determination unit 45C may notify the remote control terminal 30 of the remote operator Q who is the determined execution operator of information on the number of pieces of remote control request information to be consecutively handled, a predicted required time for each piece of the remote control request information, and a total predicted required time. In addition, the execution operator determination unit 45C may further notify the remote control terminal 30 of the remote operator Q who is the determined execution operator of information indicating progress information such as information indicating how many times handling has been made, information indicating how much of the total predicted required time has been completed, or information indicating how much of the total predicted required time remains. By notifying the remote control terminal 30 of this information, it is possible to provide the remote operator Q who uses the remote control terminal 30 with information that makes it easier to prepare for handling remote control request information.

It may be difficult for the control unit 45 to predict that remote control request information will be consecutively received from the same mobile object 10 within a predetermined period.

In this case, in a case where remote control request information is received multiple times from the same mobile object 10 within a predetermined range in terms of time or distance, the execution operator determination unit 45C may determine the same remote operator Q as an execution operator satisfying the service manager-requested condition for that mobile object 10.

In detail, in a case where the remote control request information is consecutively received from the same mobile object 10 within the predetermined period, the execution operator determination unit 45C preferentially determines a remote operator Q who handles the earlier remote control request information as the execution operator at a timing when later remote control request information is received.

Specifically, in a case where remote control request information is received from a certain mobile object 10, the execution operator determination unit 45C searches the remote control history information 44D to determine whether or not there is a remote control history for the mobile object 10 in a period until a predetermined period elapses from the remote request date and time, which is an occurrence time of the received remote control request information. When it is determined that there is a remote control history, the execution operator determination unit 45C identifies a remote operator Q who handled remote control in the remote control history, and determines the identified remote operator Q as an execution operator who will remotely control the mobile object 10 from which the remote control request information received this time is transmitted.

In addition, the execution operator determination unit 45C may further perform control so as not to determine a remote operator Q who handled the remote control of the mobile object 10 from which the earlier remote control request information was transmitted as an execution operator for other remote control request information until the predetermined period elapses. In this case, even in a case where remote control request information is suddenly and consecutively received from the same mobile object 10, a remote operator Q who handled the remote control request information received earlier can be determined as an execution operator for remote control request information received later.

In this case, there is a period in which the remote operator Q is not determined as an execution operator. Therefore, in a case where control is further performed so as not to determine a remote operator Q who handled the remote control of the mobile object 10 from which the earlier remote control request information was transmitted as an execution operator for other remote control request information until the predetermined period elapses, the remuneration amount determination unit 45E may perform control to increase the remuneration of the remote operator Q.

In this case, for example, the remuneration amount determination unit 45E may execute processing such as increasing the remuneration for remote control for the earlier remote control request information, increasing the remuneration for remote control for the later remote control request information, or giving a separate remuneration for imposing a restriction in determining an execution operator.

Similarly to the case where it is predicted that remote control request information will be consecutively received from the same mobile object 10 within the predetermined period, the execution operator determination unit 45C may preferentially determine a remote operator Q who handled the earlier remote control request information as the execution operator at a timing when later remote control request information occurs, limited to a specific time zone, a specific area D, and each type of mobile object 10.

In addition, when searching the remote control history information 44D to determine whether or not there is a remote control history for the mobile object 10 in a period until a predetermined period elapses from the remote request date and time, which is an occurrence time of the received remote control request information, the execution operator determination unit 45C may use the remote control history at any of the following times of time points.

For example, the execution operator determination unit 45C may use, as the time of the time point, any of the time when the remote control request information is received from the mobile object 10, the time when the execution operator is determined for the remote control request information from the mobile object 10, the time when the execution operator starts the remote control for the remote control request information from the mobile object 10, and the time when the execution operator ends the remote control for the remote control request information from the mobile object 10.

In addition, the execution operator determination unit 45C uses the remote request date and time of the remote control request information as the occurrence time of the remote control request information, but may use another time. For example, the occurrence time of the remote control request information may be a transmission time at which the mobile object 10 transmits the remote control request information to the information processing apparatus 40 or a time at which an event for transmitting the remote control request information occurs in the mobile object 10.

### Second Modification

In a case where a plurality of pieces of remote control request information is received or has been received from one or more mobile objects 10, respectively, in the same area D within a predetermined period, the service manager-requested condition may be information indicating that the same remote operator Q is determined as an execution operator for the plurality of pieces of remote control request information.

That is, in a case where a plurality of pieces of remote control request information are received or have been received from mobile objects 10 in the same area D within a predetermined period, the execution operator determination unit 45C determines the same remote operator Q as the execution operator for the plurality of pieces of remote control request information.

For example, after a certain mobile object 10 is remotely controlled, in a case where remote control request information is received from another mobile object 10 located within the same area D as the certain mobile object 10 within a predetermined period, the execution operator determination unit 45C determines the same remote operator Q as an execution operator who remotely controls the another mobile object 10 as the certain mobile object 10.

Immediately after handling the remote control, the remote operator Q is highly likely to have the best understanding of the situation in the area D where the remote control is performed. This determination processing makes it possible to quickly perform remote control, thereby satisfying the need of the service manager P who desires not to stop the service provided by the mobile object 10 if possible.

First, it is assumed that the execution operator determination unit 45C predicts that remote control request information will be consecutively received from different mobile objects 10 in the same area D within a predetermined period.

Specifically, the execution operator determination unit 45C searches the mobile object management information 44A for route information to acquire information on a scheduled moving route of the mobile object 10 indicated by the route information. Then, the execution operator determination unit 45C identifies an area D in which remote control request information is predicted to occur within the scheduled moving route of the mobile object 10, based on the occurrence position indicating the location where the remote control request information occurred in the past in the remote control history information 44D. Then, the execution operator determination unit 45C calculates a predicted time at which remote control request information will occur for each of the identified areas D based on the traveling speed at the time of traveling in the identified area D. Further, the execution operator determination unit 45C determines whether or not there are pieces of remote control request information predicted to occur in the same area D and predicted to occur consecutively at times within a predetermined period. When an affirmative determination is made in the determination, the execution operator determination unit 45C determines the same remote operator Q as an execution operator for the pieces of remote control request information that occur consecutively in the same area D and within the predetermined period. It is determined under any condition which remote operator Q is to be allocated as the execution operator.

Later remote control request information may occur from the occurrence time of the earlier remote control request information until the estimated required time for the remote control of the earlier remote control request information elapses. In this case, if the same remote operator Q is determined as the execution operator, it is not possible to start the remote control of the later remote control request information until the remote control of the earlier remote control request information is completed, causing the mobile object 10 that has transmitted the later remote control request information to stand by. In this case, the mobile object 10 continues to be stopped, resulting in poor efficiency.

Therefore, the execution operator determination unit 45C may determine the same remote operator Q as the execution operator for remote control request information to be consecutively received within the predetermined period only when it is determined that, among remote control request information that consecutively occur in the same area D within the predetermined period, later remote control request information occurs after the estimated required time for the remote control of the earlier remote control request information has elapsed from the occurrence time of the earlier remote control request.

The same area D may be areas overlapping each other in a certain range, not exactly the same point.

In a case where the number of times remote control request information consecutively occurs within the predetermined period exceeds a predetermined value, the execution operator determination unit 45C may determine, as the execution operator, a remote operator Q different from the remote operator Q determined at the stage where the number of times is smaller than the predetermined value. This processing reduces the likelihood that the remote operator Q will lose concentration due to the consecutive support of remote control, which impairs safety.

In addition, in a case where a cumulative time taken to handle remote control request information that consecutively occurs within the predetermined period, instead of the number of times the remote control request information occurs, exceeds a predetermined time, the execution operator determination unit 45C may determine, as the execution operator, a remote operator Q different from the remote operator Q determined at a stage where the cumulative time is shorter than the predetermined time. This processing reduces the likelihood that the remote operator Q will lose concentration due to the consecutive handling of remote control for a long period of time, which impairs safety.

In addition, in a case where remote control request information is consecutively received from the same mobile object 10 in the same region D within a predetermined period, limited to a specific time zone and a specific area D, the execution operator determination unit 45C may preferentially determine the same remote operator Q as the execution operator for that mobile object 10.

Further, when remote control request information is consecutively received from mobile objects 10 in the same region D within a predetermined period in a situation where it is difficult to grasp the status of each of the mobile objects 10 from which the remote control request information is transmitted, the execution operator determination unit 45C may preferentially determine the same remote operator Q as the execution operator for that mobile object 10. This is because, in a case where it is easy to grasp the status of the mobile object 10 from which the remote control request information is transmitted, even another remote operator Q can immediately grasp the status, and it is considered that there will be no large difference in remote control speed as compared with a case where the same remote operator Q is determined as the execution operator.

In addition, in a case where remote control request information is consecutively received within a predetermined period from mobile objects 10 in the same area D where the status of each of the mobile objects 10 does not greatly change in a short period of time, the execution operator determination unit 45C may determine the same remote operator Q as the execution operator for that mobile object 10. This is because, in an area where the status greatly changes in a short period of time, even in a case where the same remote operator Q is determined as the execution operator, the status will greatly change from that in the previous remote control, and it is considered that the time required for grasping the status will be approximately the same regardless of whether the same remote operator Q or another remote operator Q is determined. This determination method is also preferable from the viewpoint of fairly determining a plurality of different remote operators Q as execution operators as much as possible.

In addition, in a case where remote control request information is consecutively received within a predetermined period from mobile objects 10 in the same area D, limited to mobile objects 10 in a specific vehicle type, the execution operator determination unit 45C may preferentially determine the same remote operator Q as the execution operator for those mobile objects 10.

The camera arrangement, the camera performance, the performance of the obstacle detection sensor, and the like differ depending on the vehicle type of the mobile object 10. For this reason, it is considered that, even among mobile objects 10 that are in the same situation, there may exist a mobile object 10 of which the status is easy to grasp for the remote operator Q and a mobile object 10 of which the status is difficult to grasp for the remote operator Q. In the case of the mobile object 10 of which the status is easy to grasp, it is considered that, even in a case where a different remote operator Q is determined as the execution operator for that mobile object 10, the status can be grasped immediately, and there will be no great difference in remote control speed from that in a case where the same remote operator Q is determined as the execution operator for that mobile object 10. Therefore, in a case where remote control request information is consecutively received from mobile objects 10 in the same type in the same area D, the same remote operator Q may be preferentially determined as the execution operator for those mobile objects 10.

It may be difficult for the control unit 45 to predict that remote control request information will be consecutively received from mobile objects 10 in the same area D in a predetermined period.

In this case, in a case where remote control request information is received multiple times from mobile objects 10 in the same area D within a predetermined period, the execution operator determination unit 45C may determine the same remote operator Q as the execution operator satisfying the service manager-requested condition for those mobile objects 10.

In detail, in a case where the remote control request information is consecutively received from mobile objects 10 in the same area D within the predetermined period, the execution operator determination unit 45C preferentially determines a remote operator Q who handles the earlier remote control request information as the execution operator at a timing when later remote control request information is received.

Specifically, in a case where remote control request information is received from a certain mobile object 10, the execution operator determination unit 45C searches the remote control history information 44D to determine whether or not there is a remote control history in the same area D as the occurrence position of the received remote control request information and in a period until a predetermined period elapses from the remote request date and time, which is an occurrence time of the remote control request information. When it is determined that there is a remote control history, the execution operator determination unit 45C identifies a remote operator Q who handled remote control in the remote control history, and determines the identified remote operator Q as an execution operator who will remotely control the mobile object 10 from which the remote control request information received this time is transmitted.

In addition, the execution operator determination unit 45C may further perform control so as not to determine a remote operator Q who handled the remote control of the mobile object 10 from which the earlier remote control request information was transmitted as an execution operator for other remote control request information until the predetermined period elapses. In this case, even in a case where remote control request information is suddenly and consecutively received from mobile objects 10 in the same area D, a remote operator Q who handled the remote control request information received earlier can be determined as an execution operator for remote control request information received later.

In this case, there is a period in which the remote operator Q is not determined as an execution operator. Therefore, in a case where control is further performed so as not to determine a remote operator Q who handled the remote control of the mobile object 10 from which the earlier remote control request information was transmitted as an execution operator for other remote control request information until the predetermined period elapses, the remuneration amount determination unit 45E may perform control to increase the remuneration of the remote operator Q.

In addition, when searching the remote control history information 44D to determine whether or not there is a remote control history for the mobile object 10 in a period until a predetermined period elapses from the remote request date and time, which is an occurrence time of the received remote control request information, the execution operator determination unit 45C may use the remote control history at any of the following times of time points.

For example, the execution operator determination unit 45C may use, as the time of the time point, any of the time when the remote control request information is received from the mobile object 10, the time when the execution operator is determined for the remote control request information from the mobile object 10, the time when the execution operator starts the remote control for the remote control request information from the mobile object 10, and the time when the execution operator ends the remote control for the remote control request information from the mobile object 10.

In addition, the execution operator determination unit 45C uses the remote request date and time of the remote control request information as the occurrence time of the remote control request information, but may use another time. For example, the occurrence time of the remote control request information may be a transmission time at which the mobile object 10 transmits the remote control request information to the information processing apparatus 40 or a time at which an event for transmitting the remote control request information occurs in the mobile object 10.

It is assumed that, while remotely controlling a mobile object 10 with mobile object ID “V01” existing in a certain area D, remote control request information is received from another mobile object 10 with mobile object ID “V02” existing in the certain area D. In this case, the execution operator determination unit 45C may determine that, before a certain remote operator Q completes the remote control of the mobile object 10 with mobile object ID “V01”, another remote operator Q can start the remote control of the mobile object ID “V02”. In this case, the execution operator determination unit 45C may determine the another remote operator Q as an execution operator who will remotely control the mobile object 10 with mobile object ID “V02”. On the other hand, when it is determined that the another remote operator Q is not able to start the remote control of the mobile object ID “V02”, the execution operator determination unit 45C may determine the remote operator Q who has performed the remote control of the mobile object 10 with mobile object ID “V01” as an execution operator who performs the remote control of the mobile object 10 with mobile object ID “B02”.

The execution operator determination unit 45C may make the determination by comparing a remaining time until the remote control of the mobile object 10 with mobile object ID “V01” is completed with a time until the another remote operator Q starts the remote control of the mobile object 10 according to the remote control request information received from the mobile object 10 with mobile object ID “V02”. The remaining time until the remote control of the mobile object 10 with mobile object ID “V01” is completed may be calculated, for example, by a difference between the estimated required time and the time required for handling the remote control up to this point. The time until the another remote operator Q starts the remote control of the mobile object 10 may be calculated based on the remote control history.

With this determination processing, the execution operator determination unit 45C can more quickly determine an execution operator who will remotely control the mobile object 10 with mobile object ID “V02”.

Note that, limited to a case where the remote control for the earlier remote control request information is completed without any trouble such as an accident, the execution operator determination unit 45C may determine the same remote operator Q who has handled the earlier remote control request information as an execution operator who will remotely control a mobile object 10 from which later remote control request information will be transmitted. In this case, it is possible to suppress the occurrence of trouble and the prolongation of the remote control time, which is caused by determining a remote operator Q with which the trouble has occurred as an execution operator for next remote control request information.

### Third Modification

The service manager-requested condition may be information indicating that a remote operator Q who has remotely controlled a mobile object 10 similar to the mobile object 10 from which the remote control request information is transmitted within a predetermined period from the reception of the remote control request information is determined as the execution operator.

That is, the execution operator determination unit 45C determines, as the execution operator, a remote operator Q who has remotely controlled a mobile object 10 similar to the mobile object 10 from which the remote control request information is transmitted within a predetermined period from the reception of the remote control request information.

The similar mobile object 10 means that at least one of its hardware configuration, software configuration, and type is identical or similar to that of the mobile object 10 from which the remote control request information is transmitted. The similar hardware configuration means that, for example, the machine body size of the mobile object 10, the type and arrangement of the sensor 12 such as cameras provided in the mobile object 10, and the like are identical or similar. In this case, in the mobile object management information 44A or the remote control history information 44D, information such as the hardware configuration and the software configuration used for determining the similarity may be further registered in association with the mobile object ID of each mobile object 10.

For example, it is assumed that remote control request information is received from the mobile object 10 with mobile object ID “V02”. In this case, the execution operator determination unit 45C determines, as an execution operator who will remotely control the mobile object 10 with mobile object ID “V02”, a remote operator Q who has remotely controlled a mobile object 10 with mobile object ID “V11” having a machine body size and a camera arrangement similar to those of the mobile object 10 with mobile object ID “V02” within a predetermined period going back from the current point of time.

At this time, the execution operator determination unit 45C may also perform control such that a remote operator Q who has remotely controlled the mobile object 10 that is not similar to the mobile object 10 with mobile object ID “V02” within the predetermined period going back from the current point of time is prohibited from being determined as an execution operator who will remotely control the mobile object 10 with mobile object ID “V02” or is given lower priority in the determination.

It is assumed that the remote operator Q remotely controls mobile objects 10 having different machine body sizes, different camera arrangements, and the like. In this case, the angle of view of the captured image obtained by the sensor 12 of each mobile object 10, the capturing direction with respect to the mobile object 10, and the like differ. Therefore, in a case where the remote operator Q remotely controls these mobile objects 10, the operational perception, such as the sense of distance or the sense of speed, differs. Therefore, in a case where the same remote operator Q consecutively performs remote control of mobile objects 10 having different machine body sizes and different camera arrangements, the difference in operational perception during remote control is likely to increase the risk of collisions or other incidents during the remote control.

Therefore, the execution operator determination unit 45C determines, as an execution operator satisfying the service manager-requested condition, a remote operator Q who has remotely controlled a mobile object 10 similar to the mobile object 10 from which the remote control request information is transmitted within a predetermined period from the reception of the remote control request information. With this determination processing, the execution operator determination unit 45C can determine a remote operator Q who is able to perform remote control more safely as the execution operator. In addition, the execution operator determination unit 45C can reduce the likelihood of causing troubles such as accidents. In addition, the execution operator determination unit 45C can determine an execution operator so as to satisfy the need of the service manager P who desires not to stop the service provided by the mobile object 10 if possible.

Note that, in a case where it is determined that the operational perception of the remote operator Q determined as an execution operator based on the remote control request information received earlier has diminished in remotely controlling the mobile object 10 from which the remote control request information is transmitted, the execution operator determination unit 45C may permit the remote operator Q to be determined as the execution operator.

For example, in a case where a predetermined period or more has elapsed from the start of the remote control by the execution operator determined based on the remote control request information, it may be determined that the operational perception has diminished in remotely controlling the mobile object 10 based on the remote control request information.

In addition, in a case where it is determined that the operational perception of the remote operator Q determined as an execution operator based on the remote control request information received earlier remains in remotely controlling the mobile object 10 from which the remote control request information is transmitted, the execution operator determination unit 45C may preferentially determine the remote operator Q as the execution operator.

It is considered that the longer the period of the remote control of the mobile object 10 from which the remote control request information received earlier is transmitted, the more likely it is that the operational perception remains in remotely controlling the mobile object 10. Therefore, the execution operator determination unit 45C may be configured to set a predetermined period for determining that the operational perception has diminished or remains in remotely controlling the mobile object 10 from which the remote control request information received earlier is transmitted depending on the period of the remote control of the mobile object 10 based on the remote control request information received earlier.

For example, the execution operator determination unit 45C sets the predetermined period to be longer as the period of the remote control of the mobile object 10 based on the remote control request information received earlier is longer.

In addition, not limited to the period of the remote control of the same mobile object 10, even in a case where another mobile object 10 having the same or similar operational perception is continuously remotely controlled, it is considered that the operational perception of the remote control of the other mobile object 10 remains. Therefore, the execution operator determination unit 45C may determine whether or not the operational perception has diminished by adding a period of remote control of another mobile object 10 having the same or similar remote control operational perception.

### Fourth Modification

The service manager-requested condition may be information indicating that a remote operator Q from whose previous remote control a predetermined time or more has elapsed is determined as an execution operator satisfying the service manager-requested condition.

That is, the execution operator determination unit 45C determines a remote operator Q from whose previous remote control a predetermined time or more has elapsed as an execution operator satisfying the service manager-requested condition.

In detail, the execution operator determination unit 45C prohibits a remote operator Q determined as an execution operator who remotely controls the mobile object 10 from which the remote control request information is transmitted from being determined as an execution operator who remotely controls a mobile object 10 from which newly-received remote control request information is transmitted until a predetermined time elapses from the remote control.

From the viewpoint of labor, in a case where one remote operator Q remotely controls mobile objects 10 consecutively based on the remote control request information, the remote operator Q may become distracted, which may impair safety. Therefore, the execution operator determination unit 45C suppresses a remote operator Q having a high risk from being determined as the execution operator. With this processing, the execution operator determination unit 45C can achieve safer remote control, reduce the likelihood of causing troubles such as accidents, and meet the need of the service manager P who desires not to stop the service provided by the mobile object 10 if possible.

In addition, the execution operator determination unit 45C may prohibit a remote operator Q whose required time for remote control is a predetermined time or more from being determined as an execution operator who remotely controls a mobile object 10 from which newly-received remote control request information is transmitted until the predetermined time elapses from the time point at which the predetermined time or more has elapsed or from the end of the remote control.

In addition, the execution operator determination unit 45C may prohibit a remote operator Q whose accumulated time of required times for remote control is a predetermined time or more from being determined as an execution operator who remotely controls a mobile object 10 from which newly-received remote control request information is transmitted until the predetermined time elapses from the time point at which the predetermined time or more has elapsed or from the end of the remote control.

### Fifth Modification

The service manager-requested condition may be information indicating that a remote operator Q having a history of checking a traveling rule of a traveling area of a mobile object 10 from which remote control request information is transmitted is determined as the execution operator.

That is, the execution operator determination unit 45C determines a remote operator Q having a history of checking a traveling rule of a traveling area of a mobile object 10 from which remote control request information is transmitted as the execution operator.

For example, when receiving the remote control request information, the execution operator determination unit 45C preferentially determines, as the execution operator, a remote operator Q who has preliminarily checked information regarding the traveling rule corresponding to the area D where the mobile object 10 from which the remote control request information is transmitted is located among remote operators Q identified as being assignable.

For example, when receiving a request for browsing the traveling rule of the area management information 44B from the remote control terminal 30, the control unit 45 may store the remote operator ID of the remote operator Q who operates the remote control terminal 30 and the browsing date and time in association with the area ID of the area D of the browsed traveling rule of the area management information 44B as a browsing history. Then, by searching the browsing history of the area management information 44B, the execution operator determination unit 45C may identify the remote operator Q who has preliminarily checked the information regarding the traveling rule corresponding to the area D where the mobile object 10 from which the remote control request information is transmitted is located.

Note that the information processing apparatus 40 or the service manager terminal 20 may disclose information regarding a traveling rule of an area D where each of the plurality of mobile objects 10 managed by the remote control system 1 travels, and the information processing apparatus 40 or the service manager terminal 20 may manage a record of access to the traveling rule by the remote operator Q who operates the remote control terminal 30.

By determining a remote operator Q who has preliminarily grasped the information regarding the traveling rule in the area D where the mobile object 10 is located as the execution operator, the execution operator determination unit 45C can determine a remote operator Q which is able to quickly handle remote control as the execution operator. In addition, the execution operator determination unit 45C can determine an execution operator so as to satisfy the need of the service manager P who desires not to stop the service provided by the mobile object 10 if possible.

In addition, among remote operators Q who have preliminarily checked information regarding the traveling rule corresponding to the area D where the mobile object 10 from which the remote control request information is transmitted is located, the execution operator determination unit 45C may preferentially determine a remote operator Q who has checked information regarding the latest traveling rule as the execution operator.

In addition, among remote operators Q who have preliminarily checked information regarding the traveling rule corresponding to the area D where the mobile object 10 from which the remote control request information is transmitted is located, the execution operator determination unit 45C may preferentially determine a remote operator Q who has checked the information at the latest timing closest to the current time. This is because the remote operator Q who has checked the information regarding the traveling rule at the latest timing is likely to have the information regarding the traveling rule clearly remaining in his or her memory.

In addition, it is preferable that the execution operator determination unit 45C identifies a remote operator Q who has checked the information regarding the traveling rule at the latest timing, taking into account the time required for the remote operator Q to check the information regarding the traveling rule.

For example, it is assumed that the time required for the remote operator Q to confirm the information regarding the traveling rule is 5 minutes. In this case, the execution operator determination unit 45C determines, as the execution operator, a remote operator Q who has checked the information at the latest timing closest to reception of remote control request information or the current time within a period up to 5 minutes before the reception of the remote control request information.

At least a part of the traveling rule may be changed. In this case, the execution operator determination unit 45C may be configured to determine, as the execution operator, a remote operator Q who has checked the information regarding the traveling rule at the latest timing among remote operators Q who have checked the changed traveling rule.

In addition, the traveling rule may include a traveling rule applied depending on the time zone. In this case, the execution operator determination unit 45C may be configured to determine, as the execution operator, a remote operator Q who has checked the traveling rule in a time zone overlapping with a time zone in which the remote control is scheduled to be executed on the mobile object 10 from which the received remote control request information is transmitted.

For example, it is assumed that traveling rule is that the speed limit is 15 km/h during the daytime and 10 km/h during the nighttime. In this case, in a case where the time zone in which the remote control is scheduled to be executed on the mobile object 10 from which the received remote control request information is transmitted is the nighttime, the execution operator determination unit 45C determines a remote operator Q who has checked the traveling rule during the nighttime as the execution operator.

It is considered that the remote operator Q preferentially will check the traveling rule for the time zone at the checked point of time. Therefore, the execution operator determination unit 45C determines, as the execution operator, a remote operator Q who has checked the traveling rule in a time zone overlapping with a time zone in which the remote control is scheduled to be executed on the mobile object 10 from which the received remote control request information is transmitted. With this determination processing, the execution operator determination unit 45C can determine a remote operator Q who is able to execute the remote control in which the traveling rule is correctly understood as the execution operator.

In addition, in a case where the traveling rule of the area D in which a mobile object 10 that can be a remote control target is located has been changed from a predetermined period of time ago, such as the previous day, the execution operator determination unit 45C may be configured to perform control to display a display screen highlighting the change point of the traveling rule on the remote control terminal 30 of the remote operator Q. By displaying the display screen on the remote control terminal 30, the remote operator Q who operates the remote control terminal 30 can be informed that the traveling rule has been changed from a predetermined period of time ago.

In addition, the execution operator determination unit 45C may perform control so as to display a display screen highlighting the change point of the traveling rule only on the remote control terminal 30 of the remote operator Q who has checked the traveling rule a predetermined period of time ago.

In addition, the execution operator determination unit 45C may be configured to be able to disclose, to the remote control terminal 30, the number of remote operators Q who have checked information regarding the traveling rule of each of the areas D managed by the remote control system 1.

For an area D of which the information regarding the traveling rule is checked by a larger number of remote operators Q, a remote operator Q who checks that information is less likely to be determined as the execution operator. Therefore, the execution operator determination unit 45C can provide the remote operator Q with information for prompting the remote operator Q to lower the priority of work of checking the information regarding the traveling rule of the area D checked by a larger number of remote operators Q.

In addition, for an area D of which the information regarding the traveling rule is checked by a smaller number of remote operators Q, a remote operator Q who checks that information is more likely to be determined as the execution operator. Therefore, the execution operator determination unit 45C can provide the remote operator Q with information for prompting the remote operator Q to increase the priority of work of checking the information regarding the traveling rule of the area D checked by a smaller number of remote operators Q.

Furthermore, the execution operator determination unit 45C may be configured to be able to disclose only the information regarding the traveling rule of the area D where the mobile object 10 is currently traveling to the remote control terminal 30. In this case, the execution operator determination unit 45C can prevent the remote operator Q from erroneously checking the information regarding the traveling rule of the area D where the mobile object 10 is not currently traveling.

In addition, the execution operator determination unit 45C may be configured to be able to disclose, to the remote control terminal 30, information regarding the traveling rule of each of the area D where the mobile object 10 is currently traveling and the area D where the mobile object 10 is scheduled to travel in the future. The execution operator determination unit 45C may store travel schedule information of the mobile object 10 in advance in the storage unit 44, and derive the area D where the mobile object 10 is scheduled to travel in the future using the travel schedule information. In this case, the execution operator determination unit 45C can provide the remote operator Q with the traveling rule of the area D where the mobile object 10 is scheduled to travel in the future in a checkable manner.

In addition, the execution operator determination unit 45C may be configured to provide, for each remote operator Q, only information regarding the traveling rule of the area D where the mobile object 10 that can be handled by the remote operator Q exists in a checkable manner. The mobile object 10 that can be handled by the remote operator Q may be determined in advance depending on whether or not the remote operator Q is qualified or not. In this case, the execution operator determination unit 45C can suppress the remote operator Q from erroneously checking the information regarding the traveling rule of the area D where the mobile object 10 that cannot be handled by the remote operator Q travels.

In addition, the execution operator determination unit 45C may be configured to display the traveling rule checked by the remote operator Q on the remote control terminal 30 operated by the remote operator Q before the remote operator Q starts the remote control, causing the remote operator Q to start the remote control after being reminded of the traveling rule.

With such a configuration, in a case where the remote operator Q checks the traveling rules of various areas D, the remote operator Q can be reminded because the remote operator Q may not remember what the traveling rules are. In addition to the scene of the present invention, it is effective to display the traveling rule of the area D on the remote control terminal 30 operated by the remote operator Q before the remote control is started, causing the remote operator Q to start the remote control after being reminded of the traveling rule. This is particularly effective in a case where the remote operator Q remotely controls mobile objects 10 existing in areas D of the different traveling rules consecutively, because the remote operator Q may be influenced by the traveling rule under which the mobile object 10 is remotely controlled first. In addition, the execution operator determination unit 45C may be configured to, only in a case where mobile objects 10 existing in areas D of different traveling rules are remotely controlled consecutively, display the later traveling rule on the remote control terminal 30 operated by the remote operator Q. This is because it is troublesome to display traveling rules even though the traveling rules are the same. In addition, the execution operator determination unit 45C may highlight a point of change between the earlier traveling rule and the later traveling rule.

### Sixth Modification

In a case where the traveling situation of the mobile object 10 from which the remote control request information is transmitted is a predetermined situation requiring a high level of remote control ability, the service manager-requested condition may be information indicating that a remote operator Q whose required time for remotely controlling the mobile object 10 in that traveling situation is a predetermined time or less is determined as the execution operator.

That is, in a case where the traveling situation of the mobile object 10 from which the remote control request information is transmitted is a predetermined situation requiring a high level of remote control ability, the execution operator determination unit 45C determines, as the execution operator, a remote operator Q whose required time for remotely controlling the mobile object 10 in that traveling situation is a predetermined time or less.

The situation requiring the high level of remote control ability is, for example, a surrounding environmental situation such as nighttime, rainy weather, or a traffic volume equal to or greater than a threshold, a situation of the mobile object 10 itself such as a weight or a volume of a load equal to or greater than a threshold, or a ratio of the weight of the load to the weight of the mobile object 10 equal to or greater than a threshold, or the like. Information indicating the situation requiring the high level of remote control ability may be stored in the storage unit 44 in advance.

By executing this determination processing, the execution operator determination unit 45C can determine a remote operator Q who is able to quickly handle remote control as the execution operator. In addition, the execution operator determination unit 45C can determine, as the execution operator, a remote operator Q satisfying the need of the service manager P who desires not to stop the service provided by the mobile object 10 if possible.

Specifically, the execution operator determination unit 45C acquires a traveling situation of the mobile object 10 from which the received remote control request information is transmitted. For example, the execution operator determination unit 45C acquires the traveling situation of the mobile object 10 by receiving the remote control request information including information indicating a surrounding environmental situation such as time, weather, or traffic volume, or a situation of the mobile object 10 itself such as a weight or a volume of a load equal to or greater than a threshold. Furthermore, the execution operator determination unit 45C may acquire information on a surrounding environmental situation of the mobile object 10, such as weather and traffic volume, and a situation of the mobile object 10 such as a loading amount of the mobile object 10, and the like from an external system or the like connected to the network NW.

Then, it is assumed that the execution operator determination unit 45C determines that the acquired traveling situation of the mobile object 10 is a predetermined situation requiring a high level of remote control ability. In this case, based on the remote control history information 44D, the execution operator determination unit 45C determines, as the execution operator, a remote operator Q having a history of remote control in a traveling situation identical or similar to that traveling situation in the past and having the shortest average value of required times for remotely controlling mobile objects 10 in that traveling situation, among remote operators Q identified as being assignable.

In the remote control history information 44D, the traveling situation during remote control may be further stored in association with each history ID.

In addition, in a case where the traveling situation of the mobile object 10 from which the received remote control request information is transmitted is a situation requiring a high level of remote control ability, the execution operator determination unit 45C may determine a remote operator Q having a history of remote control in a traveling situation identical to that traveling situation as the execution operator.

In addition, in this case, the execution operator determination unit 45C may determine, as the execution operator, a remote operator Q having a history of remote control in a traveling situation identical to that traveling situation in a time zone overlapping with the time zone of that traveling situation.

Furthermore, in this case, the execution operator determination unit 45C may further determine, as the execution operator, a remote operator Q who has performed remote control in that traveling situation a predetermined number of times or more, and has the shortest average value of required times for remotely controlling mobile objects 10 in that traveling situation. In addition, the execution operator determination unit 45C may determine a remote operator Q having the shortest required time in the latest history as the execution operator. That is, the execution operator determination unit 45C may determine an execution operator in consideration of the latest skill of the remote operator Q.

Furthermore, in this case, the execution operator determination unit 45C may determine, as the execution operator, a remote operator Q who has a history of remote control in a traveling situation identical or similar to that traveling situation in the past, and has remotely controlled mobile objects 10 in that traveling situation a predetermined number of times or more.

Furthermore, in this case, the execution operator determination unit 45C may perform the determination processing using remote control history for a specific period such as the past six months in the remote control history information 44D.

### Seventh Modification

The service manager-requested condition may be information indicating that a remote operator Q who is remotely monitoring a traveling area of the mobile object 10 from which the remote control request information is transmitted is determined as the execution operator.

That is, the execution operator determination unit 45C determines a remote operator Q who is remotely monitoring a traveling area of the mobile object 10 from which the remote control request information is transmitted as the execution operator.

The remote operator Q is in a standby state until it is determined as the execution operator. It is inefficient to keep the remote operator Q in a standby state without doing anything.

Therefore, the execution operator determination unit 45C performs control to display, on the output unit 33 of the remote control terminal 30 of the remote operator Q, captured images of the surroundings of the mobile object 10 captured by the sensor 12 of the predetermined mobile object 10 among the plurality of mobile objects 10 managed by the remote control system 1. With such a configuration, the execution operator determination unit 45C can provide the remote operator Q with a situation around the mobile object 10 in a checkable manner.

Then, when receiving remote control request information from the mobile object 10, the execution operator determination unit 45C determines the remote operator Q of the remote control terminal 30 that has displayed the captured images of the surroundings of the mobile object 10 as the execution operator Q who is a remote operator Q remotely monitoring the traveling area of the mobile object

With this determination processing, the execution operator determination unit 45C can determine a remote operator Q who is remotely monitoring the traveling area of the mobile object 10 from which the remote control request information is transmitted as an execution operator who remotely controls the mobile object 10. In addition, the execution operator determination unit 45C can determine a remote operator Q who is able to quickly handle the remote control of the mobile object 10 as the execution operator. In addition, the execution operator determination unit 45C can determine, as the execution operator, a remote operator Q satisfying the need of the service manager P who desires not to stop the service provided by the mobile object 10 if possible.

Note that the remote operator Q who is able to remotely monitor the traveling area of the mobile object 10 may be limited to the remote operator Q who is able to remotely control the mobile object 10. In this case, the mobile object ID of the mobile object 10 that can be monitored by the remote operator Q identified by the remote operator ID may further be stored in association with the remote operator ID in the remote operator management information 44C.

Then, the execution operator determination unit 45C may perform control so as to display the captured images of the surroundings of the mobile object 10 received from the mobile object 10 on the remote control terminal 30 identified by the remote control terminal ID corresponding to the mobile object ID of the mobile object 10 in the remote operator management information 44C.

With this display control, the execution operator determination unit 45C can determine a remote operator Q who is remotely monitoring the traveling area of the mobile object 10 from which the remote control request information is transmitted and is able to remotely control the mobile object 10 as an execution operator who remotely controls the mobile object 10. In addition, the execution operator determination unit 45C can determine a remote operator Q who is able to quickly handle remote control as the execution operator. In addition, the execution operator determination unit 45C can suppress a state in which only a remote operator Q who is not able to remotely control the mobile object 10 from which the remote control request information is transmitted can remotely monitor the traveling area of the mobile object 10.

In addition, the execution operator determination unit 45C may be able to predict in advance a mobile object 10 that is highly likely to transmit remote control request information by making a determination based on AI or the like using the remote control history information 44D, the situation around the mobile object 10, and the like. In this case, the execution operator determination unit 45C may perform control to notify the remote control terminal 30 of the remote operator Q of the prediction result. With this notification processing, the execution operator determination unit 45C can provide the remote operator Q with information prompting the preliminary remote monitoring based on the prediction result.

Then, the execution operator determination unit 45C may determine a remote operator Q who has preliminarily been remotely monitoring the traveling area of the mobile object 10 from which the remote control request information is transmitted as an execution operator who remotely controls the mobile object 10.

In addition, the execution operator determination unit 45C may perform control to notify the remote control terminal 30 of information prompting the preliminary remote monitoring of the mobile object 10 based on the prediction result, instead of the prediction result. Then, when receiving the remote control request information from the mobile object 10, the execution operator determination unit 45C may determine a remote operator Q operating the remote control terminal 30 as an execution operator who remotely controls the mobile object 10.

With this determination processing, the execution operator determination unit 45C can cause the remote operator Q who is preliminarily monitoring captured images of the situation around the mobile object 10 from which the remote control request information is transmitted to directly perform remote control. Therefore, the execution operator determination unit 45C can determine a remote operator Q who is able to quickly handle remote control as the execution operator. In addition, the execution operator determination unit 45C can determine, as the execution operator, a remote operator Q satisfying the need of the service manager P who desires not to stop the service provided by the mobile object 10 if possible.

In addition, the remote operator Q may be a beginner in remote control, or the remote operator Q may not have a high remote control skill and may require a time longer than the standard required time for remote control. In this case, the execution operator determination unit 45C may determine the remote operator Q as the execution operator for remote control according to the remote control request information received from the mobile object 10 only when the remote operator Q has preliminarily been remotely monitoring the mobile object 10.

In a case where the remote operator Q is a beginner in remote control, or in a case where the remote operator Q does not have a high remote control skill and requires a time longer than the standard required time for remote control, the remote operator Q may require a longer time for remote control. On the other hand, in a case where such a remote operator Q has preliminarily been remotely monitoring the mobile object 10, even such a remote operator Q can save the time for grasping the situation, shortening the time required for remote control as much as the amount of time saved. Conversely, in a case where such a remote operator Q who has not preliminarily been remotely monitoring the mobile object 10 is determined as the execution operator, the remote operator Q requires a longer time for remote control, which may cause a delay in the service provided by the mobile object 10.

The execution operator determination unit 45C may determine whether or not the remote operator Q is a beginner in remote control or a remote operator Q who does not have a high remote control skill and requires a time longer than the standard required time for remote control, based on the remote control history information 44D. For example, the execution operator determination unit 45C determines a remote operator Q whose number of operation history records registered in the remote control history information 44D is equal to or less than a threshold as the beginner in remote control. In addition, the execution operator determination unit 45C determines that a remote operator Q whose required time included in the remote control history registered in the remote control history information 44D is longer than the standard operation time by a threshold or more is a remote operator Q who does not have a high remote control skill and requires a time longer than the standard required time for remote control. The standard operation time is an average operation time of standard remote operators Q who are neither beginners nor experts, and may be stored in the storage unit 44 in advance.

### Eighth Modification

The service manager-requested condition may be information indicating that the same remote operator Q is determined as an execution operator for a plurality of mobile objects 10 that perform cooperative operations with the mobile object 10 from which the remote control request information is transmitted.

That is, the execution operator determination unit 45C determines the same remote operator Q as an execution operator for a plurality of mobile objects 10 that perform cooperative operations with the mobile object 10 from which the remote control request information is transmitted.

For example, it may be necessary to remotely control a plurality of mobile objects 10 to be alternately operated to perform a series of operations in cooperation with each other. In this case, if a remote operator Q who grasps a series of operation situations remotely controls the plurality of mobile objects 10 that operate in cooperation with each other, each of the mobile objects 10 can be remotely controlled in a smooth manner. In addition, in a case where a remote operator Q is allocated for each mobile object 10, adjustment is required by communication or the like between the remote operators Q, which may take time accordingly. Therefore, the execution operator determination unit 45C may perform this determination processing.

For example, it is assumed that the mobile object 10 with mobile object ID “V01”, the mobile object 10 with mobile object ID “V02”, the mobile object 10 with mobile object ID “V01”, and the mobile object 10 with mobile object ID “V02” are sequentially operated in this order to perform cooperative operations. In this case, the execution operator determination unit 45C preferentially determines the same remote operator Q as an execution operator who remotely controls each of the mobile object 10 with mobile object ID “V01” and the mobile object 10 with mobile object ID “V02”.

In this case, the execution operator determination unit 45C stores in advance information indicating a condition for performing the cooperative operations.

When it is determined that the condition is satisfied, the execution operator determination unit 45C determines the same remote operator Q as an execution operator who remotely controls each of the plurality of mobile objects 10 that perform the cooperative operations.

The condition for performing cooperative operations is as follows. For example, the condition for performing cooperative operations is that a plurality of mobile objects 10 exist in a number equal to or greater than a threshold in a predetermined area, a predetermined trigger for starting cooperative operations is detected, or the like.

The execution operator determination unit 45C may perform control to display the contents of the cooperative operations on the remote control terminal 30 operated by the determined execution operator. For example, in a case where the mobile objects 10 are sequentially moved, the execution operator determination unit 45C may display information indicating the order on the remote control terminal 30.

### Ninth Modification

In the above-described embodiment and first to eighth modifications, the mode in which the execution operator determination unit 45C determines a remote operator Q satisfying the service manager-requested condition of the service manager P as the execution operator has been described.

However, the execution operator determination unit 45C may determine a remote operator Q further satisfying a remote operator-requested condition of the remote operator Q as the execution operator.

The remote operator-requested condition is information indicating a condition required by a remote operator Q for allocating the remote operator Q who remotely controls a mobile object 10.

The remote operator-requested condition is registered, for example in the storage unit 44 in advance. For example, the control unit 45 receives the remote operator-requested condition from the remote control terminal 30 operated by the remote operator Q, and stores the remote operator-requested condition in the storage unit 44 in advance. The requested condition identifying unit 45B may identify a remote operator-requested condition by reading the storage unit 44.

By determining a remote operator Q satisfying the service manager-requested condition of the service manager P as the execution operator, the remote operator Q satisfying the need of the service manager P can be determined as the execution operator. On the other hand, in some cases, the remote operator Q satisfying the need of the service manager P may be inconvenient for the remote operator Q. In this case, the number of applicants for remote operator Q may decrease, or the remote control may malfunction.

Therefore, the execution operator determination unit 45C determines a remote operator Q satisfying the service manager-requested condition and the remote operator-requested condition as the execution operator.

With this determination processing, it is possible to determine a remote operator Q satisfying the needs of both the service manager P and the remote operator Q as the execution operator.

The remote operator-requested condition may be registered by the remote operator Q in advance as described above. Note that the remote operator-requested condition is not limited to the mode in which it is registered by the remote operator Q. For example, the service manager P may determine and register a remote operator-requested condition by estimating the need of the remote operator Q.

The remote operator-requested condition is, for example, information indicating that an execution operator is determined so as to suppress a decrease in remuneration due to a difference in frequency of determination as the execution operator depending on the type of the remotely controllable mobile object 10.

For example, the following two types of cases are assumed. A remote operator Q who is able to remotely control a mobile object 10 of type “special vehicle” can remotely control a mobile object 10 of both type “special vehicle” and type “general vehicle”. In addition, a remote operator Q who is able to remotely control a mobile object 10 of type “general vehicle” can remotely control only a mobile object 10 of type “general vehicle”.

Then, it is assumed that remote control request information is received from a mobile object 10 of type “general vehicle”. In this case, it is assumed that the execution operator determination unit 45C determines a remote operator Q who is able to remotely control a mobile object 10 of both type “special vehicle” and type “general vehicle” as an execution operator who remotely controls the mobile object 10. At this time, if remote control request information is further received from a mobile object 10 of type “special vehicle”, the execution operator determination unit 45C becomes difficult to determine a remote operator Q that is able to remotely control the mobile object 10. Therefore, in a case where the execution operator determination unit 45C receives remote control request information from a mobile object 10 of type “general vehicle”, the execution operator determination unit 45C determines a remote operator Q who is able to remotely control the mobile object 10 of type “general vehicle” as the execution operator.

However, the frequency of remote control request information received from mobile objects 10 of type “special vehicle” may be lower than the frequency of the remote control request information received from mobile objects 10 of type “general vehicle”. In this case, a remote operator Q who is able to remotely control a mobile object 10 of type “special vehicle” may be determined as the execution operator less frequently and may receive less remuneration than a remote operator Q who is able to remotely control only a mobile object 10 of type “general vehicle”.

Therefore, the execution operator determination unit 45C determines, as the execution operator, a remote operator Q who is able to remotely control a mobile objects 10 of both type “special vehicle” and type “general vehicle” with respect to remote control request information for which the predicted required time for remote control is a short time equal to or less than a threshold among remote control request information received from mobile objects 10 of type “general vehicle”.

With this determination processing, the remote control ends in a short time by the determined remote operator Q. Therefore, when receiving remote control request information from a mobile object 10 of type “special vehicle” thereafter, the execution operator determination unit 45C can determine a remote operator Q who is able to remotely control the mobile object 10 of type “special vehicle” in a relatively short time as the execution operator.

The execution operator determination unit 45C may determine whether or not the predicted required time for remote control is a short time equal to or less than the threshold as follows. For example, using the remote control history information 44D, the execution operator determination unit 45C determines whether or not the predicted required time for remote control indicated by remote control request information received this time is a short time based on the operation time for the remote control corresponding to the remote control request information received in the past under the same or similar situation.

Specifically, for example, the execution operator determination unit 45C identifies the content of the remote control according to request content information included in the received remote control request information. Then, the execution operator determination unit 45C determines whether or not the predicted required time for the remote control indicated by the remote control request information received this time is a short time by using the standard required time depending on the content of the remote control.

Furthermore, a remote operator Q who is able to remotely control a mobile object 10 of type “special vehicle” may receive remote control request information from a mobile object 10 of type “special vehicle” while remotely controlling a mobile object 10 of type “general vehicle”.

Then, remote operators Q identified as being assignable by the execution operator determination unit 45C may not include the remote operator Q who is able to remotely control a mobile object 10 of type “special vehicle”. In this case, the execution operator determination unit 45C causes the remote operator Q to interrupt the remote control of the mobile object 10 of type “general vehicle” that is being handled thereby, and determines the remote operator Q of that type as an execution operator who remotely controls the mobile object 10 of type “special vehicle”.

For example, the execution operator determination unit 45C transmits remote control interruption request information to the remote control terminal 30 of the remote operator Q who is handling the remote control of the mobile object 10 of type “general vehicle”. When the remote control terminal 30 that has received the interruption request information outputs the information to the output unit 33, the remote operator Q who has visually recognized the information interrupts the remote control. Through these processes, the execution operator determination unit 45C may cause the remote operator Q to interrupt the remote control of the mobile object 10 of type “general vehicle” that is being handled thereby. Since the execution operator determination unit 45C causes the remote operator Q to interrupt the remote control of the mobile object 10 of type “general vehicle”, the execution operator determination unit 45C can determine the remote operator Q as an execution operator who remotely controls the mobile object 10 of type “special vehicle”.

Note that, among remote control request information received from mobile objects 10 of type “general vehicle”, with respect to remote control request information for which remote control can be interrupted, the execution operator determination unit 45C may cause the remote operator Q who is remotely controlling the mobile object 10 from which the remote control request information is transmitted to interrupt the remote control.

In order for the execution operator determination unit 45C to determine whether the remote control request information is remote control request information for which remote control can be interrupted, the mobile object 10 from which the remote control request information is transmitted may be configured to transmit, to the information processing apparatus 40, captured images of surroundings acquired by the sensor 12 of the mobile object 10. Then, the execution operator determination unit 45C determines whether or not there is an area around the mobile object 10 where the mobile object 10 can stop, whether or not there is another mobile object 10 around the mobile object 10 by performing image analysis on the captured images. With this determination processing, the execution operator determination unit 45C may determine whether the remote control request information transmitted from the mobile object 10 is remote control request information for which remote control can be interrupted.

Note that the determination as to whether or not the remote control request information is remote control request information for which remote control can be interrupted may be made by a user who operates the information processing apparatus 40 or the like, and the determination result may be input to the input unit 42. In this case, the execution operator determination unit 45C may determine whether or not the remote control request information is remote control request information for which remote control can be interrupted, using the determination result received from the input unit 42.

Note, when receiving remote control request information from a mobile object 10 of type “special vehicle”, the execution operator determination unit 45C can preliminarily predict that there is no remote operator Q who can be determined as the execution operator. Therefore, the execution operator determination unit 45C may be configured to preliminarily notify the remote control terminal 30 of the remote operator Q who is able to remotely control a mobile object 10 of type “general vehicle” of information indicating that there is a possibility that the remote control of the mobile object 10 of type “general vehicle” is interrupted by a remote operator Q who is able to remotely control a mobile object 10 of type “special vehicle” during the remote control, when the preliminary prediction is performed.

In this case, when the remote control is interrupted, the execution operator determination unit 45C can immediately determine the remote operator Q who is able to remotely control the mobile object 10 of type “general vehicle” as the execution operator, and resume the interrupted remote control.

In addition, the execution operator determination unit 45C may preferentially determine, as the execution operator, a remote operator Q who is monitoring a video when a mobile object 10 that is likely to be interrupted is remotely controlled. In this case, the remote operator Q who has grasped a situation up to the interruption can be preferentially allocated as the execution operator, so that the remote control can be quickly resumed even if the execution operator is changed.

In addition, during a period in which the number of remote operators Q who are able to remotely control mobile objects 10 of type “special vehicle” and are performing remote control is smaller than a predetermined number, the execution operator determination unit 45C equally determines remote operators Q who are able to remotely control mobile objects 10 of type “special vehicle” and remote operators Q who are able to control mobile objects 10 of type “general vehicle” as execution operators for remote control request information received from mobile objects 10 of type “general vehicle”.

Then, in a case where the number of remote operators Q who are able to remotely control mobile objects 10 of type “special vehicle” and are performing remote control becomes equal to or larger than a predetermined number, the execution operator determination unit 45C temporarily stops determining a remote operator Q who is able to control a mobile object 10 of type “general vehicle” as an execution operator for remote control request information received from a mobile object 10 of type “general vehicle”. In addition, with thresholds set in stages, the execution operator determination unit 45C may be configured to lower the frequency at which a remote operator Q who remotely controls a mobile object 10 of type “special vehicle” is allocated in stages as compared with the frequency at which a remote operator Q who remotely controls a mobile object 10 of type “general vehicle”.

In addition, when the number of remote operators Q who are able to remotely control mobile objects 10 of type “special vehicle” and are performing remote control is smaller than a predetermined number, the execution operator determination unit 45C may cancel the temporary stop, and preferentially determine, as the execution operator, a remote operator Q whose task status has been awaiting assignment due to the temporary stop.

Note that not all the remote operators Q who are able to remotely control mobile objects 10 of type “special vehicle” desire to remotely control mobile objects 10 of type “general vehicle”. Therefore, the execution operator determination unit 45C stores in advance in the storage unit 44 confirmation results from the remote operators Q as to whether or not they desire to remotely control mobile objects 10 of type “general vehicle”. Then, when receiving remote control request information from a mobile object 10 of type “general vehicle”, the execution operator determination unit 45C may determine whether to determine a remote operator Q who is able to remotely control a mobile object 10 of type “special vehicle” as the execution operator based on the confirmation results.

### Tenth Modification

The remote operator-requested condition may be information indicating a determination of an execution operator depending on a delay status of a service provided by a mobile object 10 from which remote control request information is transmitted.

For example, it is assumed that a remote operator Q who receives remote control request information from a certain mobile object 10 and remotely controls the mobile object 10 is determined.

In this case, for example, the execution operator determination unit 45C preferentially determines a remote operator Q who has a lot of experience in remotely controlling a mobile object 10 in a situation that is the same as or similar to that of the mobile object 10 as an execution operator who remotely controls the mobile object 10.

In this determination method, the execution operator determination unit 45C can determine a remote operator Q familiar with the remote control as an execution operator who remotely controls the mobile object 10, and can determine a remote operator Q who is able to safely and efficiently perform remote control.

However, in this case, a remote operator Q who has little experience in remotely controlling a mobile object 10 in a situation that is the same as or similar to that of the mobile object 10 is less likely to be determined as an execution operator for the mobile object 10. Furthermore, in this case, the remuneration to the remote operator Q may decrease, the motivation of the remote operator Q for work may decrease, and the like.

Therefore, the execution operator determination unit 45C may preferentially determine a remote operator Q who has little experience in remotely controlling a mobile object 10 in a situation that is the same as or similar to that of the mobile object 10 as an execution operator who remotely controls the mobile object 10.

In this determination method, the execution operator determination unit 45C can suppress a decrease in the frequency at which a remote operator Q who has little experience in remote control is determined as the execution operator and a decrease in the remuneration to the remote operator Q who has little experience in remote control.

However, in this determination method, a remote operator Q who has a lot of experience in remotely controlling a mobile object 10 in a situation that is the same as or similar to that of the mobile object 10 is less likely to be determined as an execution operator for the mobile object 10. Furthermore, in this case, the remuneration to the remote operator Q may decrease, the motivation of the remote operator Q for work may decrease, and the like. Furthermore, the remote control by the remote operator Q who has little experience in remote control may cause an increase in the time required for the remote control, leading to a decrease in the efficiency of the service provided by the mobile object 10.

Therefore, the execution operator determination unit 45C identifies a delay status of a service provided by a mobile object 10 from which remote control request information is transmitted. The delay status of the service is, for example, a delay status of delivery or the like. Then, the execution operator determination unit 45C identifies an execution operator determination method based on the identified delay status of the service, and determines an execution operator based on the identified determination method.

The execution operator determination method is, for example, based on whether the number of past experiences in remotely controlling a mobile object 10 in a situation that is the same as or similar to that of the mobile object 10 is equal to or more than a predetermined number or is less than the predetermined number, or the like.

Specifically, for example, in the execution operator determination method, in a case where the delay status of the service provided by the mobile object 10 from which the remote control request information is transmitted is “being delayed”, this indicates that a remote operator Q having a predetermined number or more of times of experience in remotely controlling a mobile object 10 in a situation that is the same as or similar to that of the mobile object 10 is preferentially determined as the execution operator. In addition, in the execution operator determination method, in a case where the delay status of the service provided by the mobile object 10 from which the remote control request information is transmitted is “on time”, this indicates that a predetermined remote operator Q is determined as the execution operator regardless of experience in remote control. In addition, in the execution operator determination method, in a case where the delay status of the service provided by the mobile object 10 from which the remote control request information is transmitted is “time to spare”, this indicates that a remote operator Q having less than a predetermined number of experiences in remotely controlling a mobile object 10 in a situation that is the same as or similar to that of the mobile object 10 is preferentially determined as the remote operator Q.

Then, the execution operator determination unit 45C may specify an execution operator determination method depending on the delay status of the service provided by the mobile object 10 from which the remote control request information is transmitted, and determine an execution operator based on the specified determination method.

With this determination processing, in a case where a delay occurs in the service provided by the mobile object 10 from which the remote control request information is transmitted, the execution operator determination unit 45C can suppress a remote operator Q having less than a predetermined number of experiences in remote control in the same or similar situation from being determined as the execution operator. In addition, the execution operator determination unit 45C can suppress an increase in the delay of the service provided by the mobile object 10.

In addition, in a case where no delay occurs in the service provided by the mobile object 10 from which the remote control request information is transmitted or there is time to spare, the execution operator determination unit 45C can determine a remote operator Q having less than a predetermined number of experiences in remote control in the same or similar situation as the execution operator. In addition, the execution operator determination unit 45C can suppress a decrease in the opportunity for a remote operator Q having less than a predetermined number of experiences in remote control in the same or similar situation to be determined as the execution operator.

Note that the execution operator determination method is not limited to the above.

For example, in the execution operator determination method, in a case where the delay status of the service provided by the mobile object 10 from which the remote control request information is transmitted is “being delayed” or “on time”, this indicates that a remote operator Q having a predetermined number or more of times of experience in remotely controlling a mobile object 10 in a situation that is the same as or similar to that of the mobile object 10 is preferentially determined as the execution operator. In addition, in a case where the delay status of the service provided by the mobile object 10 from which the remote control request information is transmitted is “time to spare”, the execution operator determination method identifies whether or not the spare time is equal to or more than a predetermined threshold. When the spare time is equal to or more than the predetermined threshold, this indicates a remote operator Q having less than a predetermined number of experiences in remotely controlling a mobile object 10 in a situation that is the same as or similar to that of the mobile object 10 is preferentially determined as the remote operator Q. In addition, when the spare time is less than the predetermined threshold, this may indicate that a remote operator Q having a predetermined number or more of times of experience in remote control in the same or similar situation is preferentially determined as the execution operator.

In addition, in a case where the delay status of the service provided by the mobile object 10 from which the remote control request information is transmitted is “time to spare”, the execution operator determination unit 45C may preferentially determine, as the execution operator, a remote operator Q having experience in remotely controlling a mobile object 10 in a situation that is the same as or similar to that of the mobile object 10 depending on the degree of margin indicating the degree of time to spare.

For example, when the degree of margin is equal to or more than a threshold, the execution operator determination unit 45C determines a remote operator Q who is a beginner in remote control as the execution operator. In addition, when the degree of margin is less than the threshold, the execution operator determination unit 45C determines, as the execution operator, a remote operator Q who is not a beginner in experience of remote control but has less than a predetermined number of experiences in remote control.

In the above description, the case where the execution operator determination unit 45C determines an execution operator depending on the number of experiences in remote control is equal to or more than the predetermined number or less than the predetermined number has been described. However, the execution operator determination unit 45C may determine an execution operator depending on whether the remote control skill is equal to or more than a predetermined value or less than the predetermined value. That is, the execution operator determination unit 45C may determine a remote operator Q whose required time for remote control is likely to be short as the execution operator when there is a delay, and determine a remote operator Q whose required time for remote control is likely to be long as the execution operator when there is time to spare.

Furthermore, the execution operator determination unit 45C may determine an execution operator depending on the content of the remote control for the mobile object 10 from which the remote control request information is transmitted in addition to the delay status of the service.

For example, in a case where the content of the remote control indicated by the request content information included in the remote control request information received from the mobile object 10 represents “easy” remote control, the execution operator determination unit 45C determines, as the execution operator, a remote operator Q having less than a predetermined number of experiences in remotely controlling a mobile object 10 in a situation that is the same as or similar to that of the mobile object 10. The “easy” remote control indicates, for example, that the result of predicting the required time for the remote control is less than a threshold, there are few complicated remote controls, there are few obstacles around the mobile object 10, there are few blind spots, the distance covered by the remote control is short, or the like. There being few complicated remote controls means that the number of times the mobile object 10 is turned is less than a predetermined number of times, or the like.

In addition, in a case where the content of the remote control indicated by the request content information included in the remote control request information received from the mobile object 10 represents “difficult” remote control, the execution operator determination unit 45C determines, as the execution operator, a remote operator Q having a predetermined number or more of times of experience in remotely controlling a mobile object 10 in a situation that is the same as or similar to that of the mobile object 10. The “difficult” remote control indicates, for example, that the result of predicting the required time for the remote control is equal to or more than a threshold, there are many complicated remote controls, or the like. There being many complicated remote controls means that the number of times the mobile object 10 is turned is equal to or more than a predetermined number of times, there are many obstacles to be avoided, there are many blind spots (there are many attention areas), there are intersections, the illuminance is low (for example, at night), or the like.

Through these determination processes, the execution operator determination unit 45C can reduce the time required for the remote control by the determined execution operator, suppress the delay of the service provided by the mobile object 10, and the like.

Furthermore, the execution operator determination unit 45C may determine an execution operator depending on the degree of delay influence in addition to the delay status of the service.

The degree of delay influence represents the magnitude of the cost incurred due to the delay, and is set in advance by the service manager P.

For example, in a case where the degree of delay influence of the mobile object 10 from which the remote control request information is transmitted is high, even if the delay status of the service is spare, the execution operator determination unit 45C determines, as the execution operator, a remote operator Q having a predetermined number or more of times of experience in remotely controlling a mobile object 10 in a situation that is the same as or similar to that of the mobile object 10.

In addition, in a case where the degree of delay influence of the mobile object 10 from which the remote control request information is transmitted is low, even if the delay status of the service is on time, the execution operator determination unit 45C may preferentially determine, as the execution operator, a remote operator Q having less than a predetermined number of experiences in remotely controlling a mobile object 10 in a situation that is the same as or similar to that of the mobile object 10.

### Eleventh Modification

Note that the service manager P may set a service manager-requested condition such that a remote operator Q matching the need of the service manager P is determined as the execution operator.

For example, the service manager P may pay a fee higher than the normal fee, and the service manager P may operate the service manager terminal 20 to set a service manager-requested condition of the service provider-requested condition management information 44E registered in the information processing apparatus 40.

For example, the service manager P may set the service manager-requested condition so as to determine only a specific remote operator Q as the execution operator. The specific remote operator Q is, for example, a remote operator Q skilled in remote control. In this case, the execution operator determination unit 45C can determine a remote operator Q who is able to perform remote control more quickly as the execution operator. In addition, the execution operator determination unit 45C can cause the mobile object 10 to continuously execute a service provided thereby without stopping the service if possible.

Note that the service manager P may be able to set the service manager-requested condition registered in the information processing apparatus 40 for free by operating the service manager terminal 20.

Furthermore, the information processing apparatus 40 may be configured to manage both items for which conditions can be set by paying fees and items for which conditions can be set for free.

For example, the control unit 45 of the information processing apparatus 40 manages service manager-requested conditions such that the service manager P can set a condition for free or at a low price less than a predetermined price for an item including a condition essential for remote control among a plurality of items of service manager-requested conditions. The condition essential for remote control is, for example, possession of a special license.

Furthermore, for example, the control unit 45 manages service manager-requested conditions such that the service manager P can set a condition for a fee or at a high price equal to or more than a predetermined price for an item including a condition not essential for remote control among a plurality of items of service manager-requested conditions. The condition not essential for remote control is, for example, that the remote operator Q is an expert.

Then, when receiving remote control request information, the execution operator determination unit 45C may determine a remote operator Q satisfying the service manager-requested condition, among remote operators Q identified as being assignable, as an execution operator who remotely controls the mobile object 10 from which the remote control request information is transmitted.

In addition, the execution operator determination unit 45C may determine a remote operator Q satisfying the service manager-requested condition as the execution operator only under a specific condition such as a case where a delay occurs in the service provided by the mobile object 10 from which the remote control request information is transmitted.

In addition, when a plurality of service manager-requested conditions are registered in the service provider-requested condition management information 44E of the storage unit 44, the execution operator determination unit 45C may manage a priority in association with each of the conditions. In addition, the execution operator determination unit 45C may use one or more conditions set in advance or set by the service manager P, among the plurality of service manager-requested conditions registered in the service provider-requested condition management information 44E, as service manager-requested conditions used for determining an execution operator.

For example, the service provider-requested condition management information 44E may have registered therein a plurality of service manager-requested conditions described in each of the above-described embodiment and first to eighth modifications. Furthermore, the service provider-requested condition management information 44E may have registered therein further service manager-requested conditions such as determining a skilled remote operator Q having higher skill or having a lot of experience as the execution operator, determining a remote operator Q having experience in remote control in the same region/scene/situation in the past as the execution operator, determining a remote operator Q designated by the service manager P, and determining a remote operator Q who has already checked information regarding a traveling rule of an area D at the time of receiving remote control request information.

In addition, the execution operator determination unit 45C may fail to determine a remote operator Q satisfying the service manager-requested condition and instead determine a remote operator Q satisfying a condition different from the service manager-requested condition as the execution operator. In this case, the execution operator determination unit 45C may perform processing of refunding a part of the fee paid at the time of setting the condition to the service manager P. Furthermore, in this case, the execution operator determination unit 45C may be configured not to refund a part of the fee paid at the time of setting the condition to the service manager P.

In this case, if the remote operator Q determined as the execution operator and satisfying the different condition performs remote control equivalent to that of the remote operator Q satisfying the set service manager-requested condition, a part of the fee may not be refunded. The case where the equivalent remote control is performed is, for example, a case where the remote control ends within a time equivalent to the time required for the remote control by the remote operator Q satisfying the service manager-requested condition.

In addition, in a case where the execution operator determination unit 45C determines a remote operator Q satisfying a condition different from the service manager-requested condition as the execution operator, remote control with reduced quality may be performed as compared to the remote control requested by the set service manager-requested condition. In this case, the execution operator determination unit 45C may determine a refund amount of the fee to be refunded to the service manager P depending on the degree of the reduced quality. For example, the execution operator determination unit 45C may determine the refund amount depending on a difference between a required time for remote control designated by the set service manager-requested condition and an actual required time. Note that the execution operator determination unit 45C may give back, to the service manager P, points, a coupon ticket, or the like instead of money.

In addition, in a case where the execution operator determination unit 45C determines a remote operator Q satisfying a condition different from the service manager-requested condition as the execution operator, the following processing may be performed. For example, the execution operator determination unit 45C may notify the service manager terminal 20 of the service manager P who has set the service manager-requested condition of information indicating that an execution operator satisfying the condition could not be determined. Then, the execution operator determination unit 45C may receive a change in the setting of the service manager-requested condition, a temporary change in the setting of the service manager-requested condition, or a selection of a remote operator Q from the service manager terminal 20, and update the service provider-requested condition management information 44E according to the received information.

### Twelfth Modification

Note that the remote operator Q may be able to set a remote operator-requested condition such that a remote operator Q matching the need of the remote operator Q is determined as the execution operator.

For example, the remote operator-requested condition may be set by the remote operator Q either for a fee or for free. Furthermore, the information processing apparatus 40 may be configured to manage both items for which conditions can be set by paying fees and items for which conditions can be set for free with respect to remote operator-requested conditions.

The remote operator-requested conditions include the following conditions in addition to the conditions described in the ninth and tenth modifications. For example, the remote operator-requested conditions include a remote control content, a type of mobile object 10 that is a remote control target, a target area D where the mobile object 10 that is a remote control target travels, a required time for remote control, an interval until the next remote control, a remuneration amount, and the like.

The remote control content is, for example, obstacle avoidance, departure determination, remote control by steering wheel operation, remote control by button operation, or the like. The type of mobile object 10 that is the remote control target is, for example, only a small mobile object 10, only a mobile object 10 traveling on a public road, or the like. The target area D where the mobile object 10 that is the remote control target travels is, for example, only a mobile object 10 existing in a certain area D. In addition, the required time for remote control is, for example, within an expected required time of 15 minutes. The interval until the next remote control is, for example, an interval of 15 minutes or more. The remuneration amount is, for example, only remote control request information with a unit price of 500 yen or more.

Furthermore, the control unit 45 of the information processing apparatus 40 may be configured to manage only conditions that can be designated within the range of the skills and abilities of the remote operators Q among a plurality of remote operator-requested conditions in a settable manner.

When receiving remote control request information, the execution operator determination unit 45C determines a remote operator Q satisfying the remote operator-requested condition as an execution operator who remotely controls a mobile object 10 from which the remote control request information is transmitted.

The execution operator determination unit 45C may not be able to specify a remote operator Q satisfying the remote operator-requested condition. In this case, the execution operator determination unit 45C identifies a remote operator Q who is able to handle remote control indicated by the received remote control request information, based on information such as the skill or ability range of each of the plurality of remote operators Q registered in the remote operator management information 44C. Then, the execution operator determination unit 45C notifies the remote control terminal 30 of the identified remote operator Q of a remote control handling request indicated by the remote control request information. Furthermore, at this time, the execution operator determination unit 45C may further notify information indicating whether or not the remote control can be handled under the condition that the remuneration is increased.

When receiving information indicating that the remote operator Q is able to handle remote control from the remote control terminal 30 according to an operation instruction from the remote operator Q, the execution operator determination unit 45C may determine the remote operator Q as the execution operator.

In addition, the execution operator determination unit 45C may detect that the number of assignable remote operators Q is less than the threshold, or predict that the number of assignable remote operators Q is less than the threshold.

In this case, the execution operator determination unit 45C identifies a remote operator Q who is able to handle remote control indicated by the received remote control request information, based on information such as the skill or ability range of each of the plurality of remote operators Q registered in the remote operator management information 44C. Then, the execution operator determination unit 45C may also transmit, to the remote control terminal 30 of the identified remote operator Q, information requesting that at least some of the settings of the remote operator-requested conditions registered in the storage unit 44 be temporarily invalidated or changed. When receiving information indicating permission for invalidation or change from the remote control terminal 30 according to an operation instruction from the remote operator Q, the execution operator determination unit 45C may temporarily invalidate or change at least some of the settings of the remote operator-requested conditions registered in the storage unit 44.

In this case, the execution operator determination unit 45C may temporarily invalidate or change at least some of the settings of the remote operator-requested conditions registered in the storage unit 44. In this case, it is preferable to conclude in advance a contract that permits the information processing apparatus 40 to invalidate or change the remote operator-requested condition without consent of the remote operator Q.

Then, using the invalidated or changed remote operator-requested condition, the execution operator determination unit 45C may determine an execution operator in the same manner as described above.

### Thirteenth Modification

In the above-described embodiment and modifications, the mode in which the remote operator-requested condition is registered in advance in the remote operator-requested condition management information 44F has been described as an example.

However, when receiving remote control request information, the execution operator determination unit 45C may receive a service manager-requested condition set by the service manager P from the service manager terminal 20 and determine an execution operator.

In addition, the execution operator determination unit 45C selects a service manager P from which the service manager-requested condition is to be set in advance, and notifies the service manager terminal 20 of the service manager P in advance that the service manager P is a person who sets a condition. Upon receiving remote control request information from the mobile object 10, the execution operator determination unit 45C transmits a request for setting service manager request information to the service manager terminal 20 of the service manager P selected in advance. Then, the execution operator determination unit 45C may determine an execution operator according to the service manager request information received from the service manager terminal 20.

Specifically, for example, it is assumed that the information processing apparatus 40 receives remote control request information from the mobile object 10. In this case, the execution operator determination unit 45C identifies an assignable remote operator Q in the same manner as in the above-described embodiment.

Then, the execution operator determination unit 45C extracts a remote operator Q satisfying the predetermined condition for selecting the remote operator Q set in advance by the service manager P, based on the position and time of occurrence of the received remote control request information, the type of the mobile object 10 from which the remote control request information is transmitted, the request content information, and the like. Then, the execution operator determination unit 45C creates operator selection reference information for the extracted remote operator Q, the operator selection reference information being referred to when the service manager P selects the remote operator Q, using the information regarding the remote operator Q registered in the remote operator management information 44C and the remote control history information 44D.

The operator selection reference information includes, for example, information such as a past history in remotely controlling a mobile object 10 in a situation that is the same as or similar to that of the mobile object 10 from which the received remote control request information is transmitted, a fee of the remote operator Q required when remote control indicated by the remote control request information is performed, and the like.

The execution operator determination unit 45C transmits the created operator selection reference information to the service manager terminal 20 of the service manager P selected in advance as a request for setting service manager request information.

The control unit 25 of the service manager terminal 20 displays the operator selection reference information received from the information processing apparatus 40 on the output unit 23.

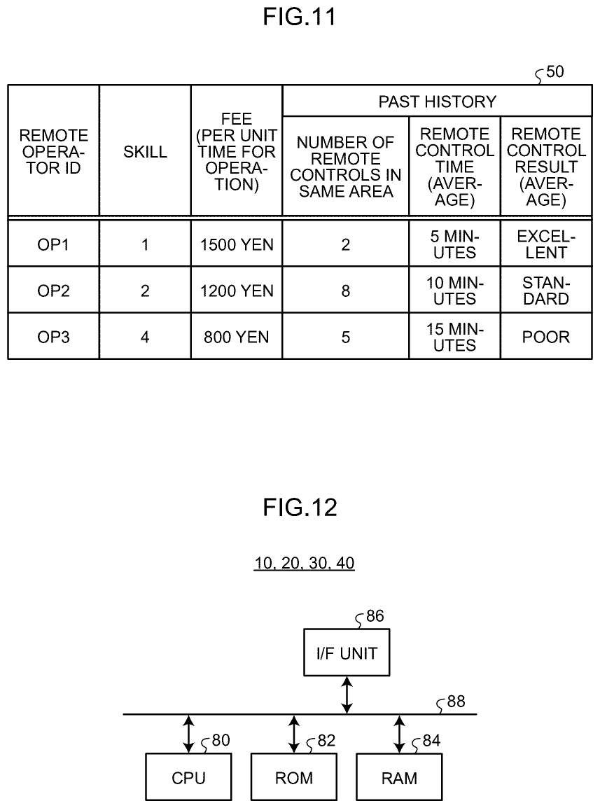

FIG. 11 is a schematic diagram of an example of a screen 50 on which the operator selection reference information displayed on the output unit 23 of the service manager terminal 20 is displayed.

The operator selection reference information is, for example, information in which a remote operator ID, a skill, a fee, and a past history of a remote operator Q are associated with each other.

The skill is determined depending on the qualification information, certification information, remote control performance (total number of times or total time), and the like of the remote operator Q identified by the corresponding remote operator ID. The fee is a unit price per unit time for operation, and is set depending on the skill, and the higher the skill, the higher the fee. Note that the fee is not limited to the fee per time for operation, and may be a fee per task. In addition, the fee may be set based on the remote control content. For example, the fee is set such that the fee is set higher for a remote control content that involves a heavier load, such as steering wheel operation or button operation.

The past history includes, for example, the number of remote controls, a remote control time, a remote control result, and the like in an area D that is the same as the area D where the mobile object 10 from which the remote control request information is transmitted is located.

The information included in the past history may be appropriately settable according to an operation instruction from the user or the like. The past history may include the number of remote controls in a similar area D in addition to the same area D, the number of remote controls similar to that in the remote control content indicated by the remote control request information, and the like.

In addition, the execution operator determination unit 45C may create operator selection reference information by using a remote control history in an area D that is the same as the area D where the mobile object 10 from the received remote control request information is transmitted exists in the remote control history information 44D and at a time that is the same as the time at which the remote control request information is received. In addition, the execution operator determination unit 45C may receive a setting indicating which period of the remote control history to use in the remote control history information 44D, and create operator reference information using the remote control history information for the set period.

In addition, the execution operator determination unit 45C may create operator reference information further including information indicating a communication status at the time of past remote control. This is because, in a case where the communication status is poor, even a highly skilled remote operator Q may not be able to perform remote control properly.

The service manager P selects the remote operator ID of the desired remote operator Q by operating the input unit 22 while viewing the display screen 50 displayed on the output unit 23 of the service manager terminal 20. The control unit 25 of the service manager terminal 20 transmits, to the information processing apparatus 40, service manager request information including the remote operator ID for which the input has been received.

The execution operator determination unit 45C of the information processing apparatus 40 may determine a remote operator Q identified by the remote operator ID indicated by the service manager request information received from the service manager terminal 20 as the execution operator.

### Fourteenth Modification

Next, a method of determining a remuneration amount by the remuneration amount determination unit 45E will be described.

The needs of the service manager P include not only the need to handle remote control safely and quickly and not to stop the service if possible, but also the need to reduce the remuneration to the remote operator Q if possible. Therefore, the service manager P sets the service manager-requested condition while balancing the service quality and the cost.

In the present modification, it is assumed that the service manager P designates, as the execution operator, a remote operator Q corresponding to remote control request information transmitted only from a mobile object 10 in the area D managed by the service manager P. In this case, the remuneration amount determination unit 45E charges the service manager P for the designation and determines a remuneration amount higher than the normal remuneration amount for the remote operator Q.

Note that the remuneration may be in the form of cash or electronic money. The electronic money also includes electronic points that can be used on a specific side. In addition, the remuneration may be a temporary privilege advantageous to the remote operator Q, such as being preferentially determined as an execution operator.

In the present modification, according to the remote control request information transmitted from the mobile object 10 existing in the area D managed by the service manager P, the remote operator Q remotely controls only the mobile object 10 existing in that area D. Therefore, the remote operator Q can quickly perform the remote control of the mobile object 10 after having a thorough knowledge of the situation and the traveling rule of the area D that the remote operator Q is in charge of. Furthermore, the information processing apparatus 40 can improve the quality of service provided by the mobile object 10.

On the other hand, in this case, the remote operator Q remotely controls only mobile objects 10 existing in the same area D. Therefore, the remote operator Q may not be determined as an execution operator who executes remote control according to remote control request information received from a mobile object 10 existing in another area D, resulting in a decrease in income. For this reason, the remote operator Q may not desire to remotely control only mobile objects 10 existing in the same area D.

Therefore, the remuneration amount determination unit 45E determines a remuneration amount higher than the normal remuneration amount as a remuneration for remote control for a remote operator Q set to remotely control only mobile objects 10 existing in the same area D. With this determination processing, the remuneration amount determination unit 45E can suppress a decrease in the income of the remote operator Q. Furthermore, the remuneration amount determination unit 45E can suppress a decrease in the number of remote operators Q who desire to be set to remotely control only mobile objects 10 existing in the same area D.

Note that the area D managed by one service manager P may be one area D, a plurality of areas D, or a partial area in a certain area D. In addition, the area D managed by one service manager P may be an area designated by the service manager P.

The remuneration amount determination unit 45E may determine an amount of charging the service manager P for the designation, depending on the number of designated areas D, the size of the area D, the number of mobile objects 10 traveling in the area D, the number of pieces of remote control request information that occur in the area D, the content of remote control such as the degree of difficulty in remote control for the remote control request information, and the like. The remuneration amount determination unit 45E may calculate the number of pieces of remote control request information that occur in the area D by using the remote control history information 44D or by simulation. Furthermore, the remuneration amount determination unit 45E may determine a remuneration amount higher than the normal remuneration amount to be determined for the remote operator Q by using a similar index.

In addition, the service manager P may be configured to be able to designate a remote control method indicating how to remotely control the designated remote operator Q. In this case, the remuneration amount determination unit 45E of the information processing apparatus 40 receives the remote operator ID of the designated remote operator Q and the information indicating the remote control method from the service manager terminal 20. Then, when the remote operator Q identified by the received remote operator ID is determined as the execution operator, the remuneration amount determination unit 45E may determine a charge amount and a remuneration amount based on the content of the remote control method corresponding to the remote operator ID.

The remote control method indicating how to perform remote control is, for example, information indicating that the mobile object 10 existing in the designated area D is to be remotely monitored at all times or when a predetermined event occurs. In this case, the information processing apparatus 40 can prompt the remote operator Q to preliminarily grasp the situation of the area D by remotely monitoring the area D before the remote operator Q is determined as the execution operator, that is, before remote control request information is received. Furthermore, when receiving remote control request information from the mobile object 10 existing in the area D, the information processing apparatus 40 can immediately cause the remote operator Q to execute remote control.

Furthermore, in this case, in order to cause the remote operator Q to remotely monitor the area D before receiving remote control request information, the remuneration amount determination unit 45E determines a charge amount and a remuneration amount higher than the charge amount and the remuneration amount for normal remote control. Furthermore, the remuneration amount determination unit 45E may determine a charge amount and a remuneration amount depending on the time or the number of times remote monitoring has been performed.

In addition, it is assumed that a specific remote operator Q is set to remotely control only mobile objects 10 existing in the same area D according to an instruction made from the service manager P by operating the service manager terminal 20. In addition, it is assumed that the specific remote operator Q is set to remotely control only mobile object 10 existing in the area D to be remotely controlled according to an instruction made by operating the remote control terminal 30. In this case, the remuneration amount determination unit 45E may determine a normal charge amount and a normal remuneration amount as an amount of charging the service manager P and a remuneration to the remote operator Q.

### Fifteenth Modification

In the present modification, the remuneration amount determination unit 45E determines a remuneration amount depending on the login status of the remote operator Q.

In detail, the remuneration amount determination unit 45E determines a remuneration amount such that the remuneration to the remote operator Q is higher as the duration is longer in which the remote operator Q is logged in to the system of the information processing apparatus 40 by operating the remote control terminal 30 to remain assignable.

With this determination processing, the remuneration amount determination unit 45E can support an increase in the number of remote operators Q in the assignable state as much as possible.

In particular, in a situation where the number of assignable remote operators Q is small or is likely to be small relative to the number of mobile objects 10 included in the remote control system 1, or in a situation where the number of assignable remote operators Q is small or is likely to be small relative to the number of times remote control request information is received or is expected to be received, the longer the remote operator Q remains logged in, the more the reduction in the number of assignable remote operators Q can be suppressed. Furthermore, in this case, the execution operator determination unit 45C can determine, as the execution operator, a remote operator Q satisfying the service manager-requested condition, which is the need of the service manager P.

Therefore, when it is determined that the number of assignable remote operators Q is small or is likely to be small relative to the number of mobile objects 10 included in the remote control system 1, the remuneration amount determination unit 45E may determine a remuneration amount such that the remuneration to the remote operator Q is higher as the duration is longer in which the remote operator Q remains assignable.

In addition, when it is determined that the number of assignable remote operators Q is small or is likely to be small relative to the number of times remote control request information is received or is expected to be received, the remuneration amount determination unit 45E may determine a remuneration amount such that the remuneration to the remote operator Q is higher as the duration is longer in which the remote operator Q remains assignable.

For example, the remuneration amount determination unit 45E may determine a remuneration amount such that the remuneration to the remote operator Q becomes higher than usual by applying a premium to the remuneration amount according to remote control request information or by applying a premium corresponding to the length of the login duration.

Note that the situation where the number of assignable remote operators Q is small or is likely to be small relative to the number of mobile objects 10 included in the remote control system 1, or the situation where the number of assignable remote operators Q is small or is likely to be small relative to the number of times remote control request information is received or is expected to be received occurs temporarily in many cases. Therefore, the remuneration amount determination unit 45E may determine a remuneration amount such that the remuneration to the remote operator Q becomes higher than usual, limited to a predetermined period after determining that such a situation has occurred.

This predetermined period may be a period from when the remuneration amount determination unit 45E detects that the situation in which the number of assignable remote operators Q is smaller relative to the number of times remote control request information is received from mobile objects 10 per unit time has been improved until any timing.

Furthermore, the remuneration amount determination unit 45E may determine a remuneration amount such that the remuneration is higher than usual only for some of the remote operators Q who remain logged in to the system of the information processing apparatus 40.

For example, when the number of remote operators Q who are able to remotely control vehicle type “special vehicle” and are being logged in relative to the number of mobile objects 10 of vehicle type “special vehicle” is less than a predetermined value, the remuneration amount determination unit 45E may determine a remuneration amount such that the remuneration to the remote operator Q who is able to remotely control vehicle type “special vehicle” and is logged in is higher than usual. Furthermore, for example, the remuneration amount determination unit 45E may determine the remuneration amount so as to increase the remuneration, limited to a case where the remote operator Q whose login duration exceeds a predetermined time or more still remains logged in.

Furthermore, in a situation where the number of assignable remote operators Q is small or is likely to be small relative to the number of mobile objects 10 included in the remote control system 1, or in a situation where the number of assignable remote operators Q is small or is likely to be small relative to the number of times remote control request information is received or is expected to be received, the remuneration amount determination unit 45E may determine a remuneration amount such that the remuneration to the remote operator Q who is newly logged in to the system of the information processing apparatus 40 is higher than usual. With this determination processing, the remuneration amount determination unit 45E can support an increase in the number of remote operators Q who are logged in to the system.

Furthermore, the remote operator Q may be able to set a period of login to the system of the information processing apparatus 40. The remuneration amount determination unit 45E may be configured to, in a case where a request for extending the login period is received from the remote control terminal 30, set the login period to be extended for the remote operator Q who operates the remote control terminal 30 in exchange for a specific condition such as an increase in remuneration.

Note that the information processing apparatus 40 receives the request for extending the login period from the remote control terminal 30, for example, in a case where the number of remote operators Q who are being logged in to the system is smaller or is likely to be smaller than the number of mobile objects 10.

### Sixteenth Modification

In the present modification, the remuneration amount determination unit 45E determines a remuneration amount depending on whether or not the remote operator Q uses an optional function for remote control.

The remote operator Q performing remote control remotely controls the mobile object 10 by operating the remote control terminal 30 via dedicated software or a browser downloaded from the information processing apparatus 40 and installed on the remote control terminal 30. There may be optional functions provided by the dedicated software or browser.

Therefore, the remuneration amount determination unit 45E may determine a remuneration amount depending on whether or not the remote operator Q uses an optional function when remotely controlling the mobile object 10.

Since the optional function is not an essential function, it is considered that a usage fee for using the optional function is required. Therefore, in a case where the remote operator Q performs remote control using the optional function, the remuneration amount determination unit 45E may determine an amount of remuneration to the remote operator Q for the remote control of the mobile object 10 based on the usage fee. The fee for using the optional function may be either a flat-rate fee (unlimited-use) or a pay-per-use fee charged depending on the number of times or the like.

Next, examples of optional functions will be described.

The optional functions are, for example, the following functions.
A function of displaying detection frames attached to objects existing around the mobile object 10 in the captured images of the surroundings of the mobile object 10 displayed on the output unit 33 of the remote control terminal 30 during remote control.
A function of displaying, as an alert, a risk of collision with the mobile object 10 derived based on a result of predicting movement of objects around the mobile object 10 in the captured images of the surroundings of the mobile object 10 displayed on the output unit 33 of the remote control terminal 30 during remote control.
A function of displaying distance perception support information regarding distances to objects around the mobile object 10 in the captured images of the surroundings of the mobile object 10 displayed on the output unit 33 of the remote control terminal 30 during remote control.
A function of displaying information indicating a guide of a turning route for turning the mobile object 10 by remote control in the captured images of the surroundings of the mobile object 10 displayed on the output unit 33 of the remote control terminal 30 during remote control.

Note that the remote operator Q may be able to switch any function on among the plurality of optional functions by paying the fee during remote control.

In addition, the execution operator determination unit 45C may perform control to display the content of the remote control on the output unit 23 of the remote control terminal 30 of the remote operator Q determined as the execution operator for the remote control request information. At this time, the execution operator determination unit 45C extracts a remote control history identical to the content of the remote control based on the remote control history information 44D, and calculates a required time for remote control for each of the case where the optional function is not used and the case where the optional function is used. For the required time, either a statistical value or an average value may be used.

Then, the execution operator determination unit 45C may compare the calculated required times, and perform control so as to output information recommending the use of the optional function to the output unit 33 of the remote control terminal 30 when the required time in the case where the optional function is used is shorter than the required time in the case where the optional function is not used.

In addition, the execution operator determination unit 45C may compare the calculated required times, and perform control so as to output information not recommending the use of the optional function to the output unit 33 of the remote control terminal 30 when the required time in the case where the optional function is used is longer than the required time in the case where the optional function is not used.

In a case where the remote operator Q remotely controls the mobile object 10 by operating the remote control terminal 30 using the optional function, it is considered that the required time for the remote control can be shortened as compared with that in the case where the optional function is not used. In addition, it is considered that the evaluation of the remote operator Q and the evaluation of the remote control are improved by shortening the required time. Accordingly, the frequency at which the execution operator determination unit 45C determines the remote operator Q as the execution operator increases, and the remuneration to the remote operator Q also increases.

Therefore, the execution operator determination unit 45C may perform control to display, on the output unit 23 of the remote control terminal 30, information on comparison between the transition of the remuneration amount in the case where the optional function is used and the transition of the remuneration amount in the case where the optional function is not used. With this display control, the execution operator determination unit 45C can provide the remote operator Q with information capable of supporting the selection of the optional function.

In addition, in a case where the remote operator Q remotely controls the mobile object 10 by operating the remote control terminal 30 using the optional function, it is considered that the remote control can be performed more safely as compared with that in the case where the optional function is not used. Therefore, the execution operator determination unit 45C calculates the transition of the remuneration including an accident occurrence rate resulting from the remote control of the mobile object 10 and a cost associated with accidents based on the remote control history information 44D, the simulation results, and the like. Then, the execution operator determination unit 45C may perform control to display these calculation results on the output unit 23 of the remote control terminal 30.

Note that the remote operator Q may remotely control a mobile object 10 managed by another information processing apparatus 40 in addition to the mobile object 10 managed by the information processing apparatus 40. In a case where the remote operator Q remotely controls a mobile object 10 managed by another information processing apparatus 40 by using the remote control terminal 30 provided from the information processing apparatus 40 or the software of the remote control terminal 30, the remuneration amount determination unit 45E may additionally charge a fee for using the remote control terminal 30 or the software of the remote control terminal 30.

Furthermore, in this case, in a case where the optional function available in the remote control terminal 30 is used, the remuneration amount determination unit 45E may additionally charge a usage fee.

When receiving remote control request information, the execution operator determination unit 45C may preferentially determine a remote operator Q using an optional function as the execution operator. This is because the remote operator Q using the optional function can perform remote control more safely and quickly than a remote operator Q who does not use the optional function.

In addition, the execution operator determination unit 45C may determine whether to preferentially determine a remote operator Q using an optional function as the execution operator depending on the content of the remote control according to the remote control request information.

For example, in a case where the content of the remote control indicates that the remote control is easy to execute, such as the number of turns during the remote control being smaller than a predetermined threshold or the number of surrounding obstacles being smaller than a predetermined number, the execution operator determination unit 45C does not preferentially determine a remote operator Q using an optional function as the execution operator.

In addition, in a case where the content of the remote control indicates that the remote control is hard to execute, such as the number of turns during the remote control being equal to or greater than a predetermined threshold or the number of surrounding obstacles being greater than a predetermined number, the execution operator determination unit 45C preferentially determines a remote operator Q using an optional function as the execution operator.

In a case where the execution operator determination unit 45C preferentially determines a remote operator Q using an optional function as the execution operator, the execution operator determination unit 45C may perform control to display, on the output unit 33 of the remote control terminal 30, a result of comparison between the frequency at which a remote operator Q using an optional function is determined as the execution operator and the frequency at which a remote operator Q not using an optional function is determined as the execution operator. With this display processing, the execution operator determination unit 45C can prompt a remote operator Q not using an optional function to use the optional function.

In addition, the execution operator determination unit 45C may display, on the remote control terminal 30 of the remote operator Q, the ratio of the service managers P who have set the condition of “preferentially assigning a remote operator Q using an optional function” among the service managers P to prompt the use of the optional function.

### Seventeenth Modification

In the present modification, the remuneration amount determination unit 45E determines a remuneration amount depending on the period until the start or the completion of the remote control of the remote operator Q determined as the execution operator.

For example, the remuneration amount determination unit 45E determines a remuneration amount such that the remuneration is higher in a case where a remote operator Q determined as the execution operator immediately starts remote control within a predetermined period from the determination as the execution operator.

In addition, the remuneration amount determination unit 45E determines a remuneration amount so that the remuneration is lower in a case where a remote operator Q determined as the execution operator starts remote control after a predetermined period or more elapses from the determination as the execution operator.

Note that, in a case where the control unit 45 evaluates the remote control by the remote operator Q according to the period until the start of the remote control by the remote operator Q determined as the execution operator, the remuneration amount determination unit 45E may not execute the processing of increasing or decreasing the remuneration amount.

In addition, the remote operator Q performs work of confirming the situation before starting the remote control of the mobile object 10. Therefore, the remuneration amount determination unit 45E may determine a remuneration amount such that the remuneration is higher in a case where a remote operator Q determined as the execution operator immediately starts the work within a predetermined period from the determination as the execution operator.

The remuneration amount determination unit 45E may determine that the work has been started by detecting a movement of the line of sight corresponding to the confirmation work of the remote operator Q using a camera or the like or by detecting a pressure on a button for the confirmation work or the like.

In addition, the remuneration amount determination unit 45E may determine the predetermined period according to the time required for the situation confirmation work. Further, the predetermined period may be set according to an instruction made from the service manager P by operating the service manager terminal 20. In this case, the service manager P can set his/her desired predetermined period.

The remote control request information is classified into two types. For example, the remote control request information is classified into remote control request information whose occurrence can be predicted based on the remote control history information 44D and remote control request information whose occurrence cannot be predicted and which occurs suddenly based on the remote control history information 44D.

In the case of remote control request information whose occurrence can be predicted, the execution operator determination unit 45C can determine an execution operator corresponding to the remote control request information in advance. However, in the case of remote control request information which occurs suddenly, it is difficult for the execution operator determination unit 45C to determine an execution operator corresponding to the remote control request information in advance.

For this reason, the remuneration amount determination unit 45E may determine a remuneration amount such that the remuneration is higher in a case where the remote operator Q determined as the execution operator for the remote control request information which suddenly occurs immediately starts the remote control within the predetermined period than in a case where the remote operator Q determined as the execution operator for the remote control request information whose occurrence can be predicted immediately starts the remote control within the predetermined period.

In addition, the remuneration amount determination unit 45E may determine a remuneration amount such that the remuneration is higher in a case where a remote operator Q determined as the execution operator completes remote control within a predetermined period. Furthermore, the remuneration amount determination unit 45E may determine a remuneration amount such that the remuneration is lower in a case where the remote operator Q determined as the execution operator completes remote control after a predetermined period or more elapses.

The predetermined period may be, for example, a standard required time set in advance for each remote control content. Furthermore, the predetermined period may be an average value of required times for remote control calculated based on the remote control history information 44D. Further, the predetermined period may be set by the service manager P operating the service manager terminal 20.

### Eighteenth Modification

In the present modification, in a case where the content of remote control indicated by received remote control request information is changed, the remuneration amount determination unit 45E changes the remuneration amount according to the changed content.

For example, the remote control content indicated by the received remote control request information may be changed due to a change in the situation or the like around the mobile object 10 while the remote operator Q, who is an execution operator, is remotely controlling the mobile object 10. In this case, the remuneration amount determination unit 45E changes the remuneration amount according to the changed content.

For example, remote control for avoiding two mobile objects 10 parked on the road may end with remote control in which one mobile object 10 is avoided by a movement of one mobile object 10 that is being remotely controlled. In this case, the remuneration amount determination unit 45E changes the determined remuneration amount so as to decrease by the amount corresponding to processing of avoiding one mobile object 10.

Furthermore, in a case where the originally scheduled difficulty level of the remote control has changed due to a change in the situation around the mobile object 10 that is being remotely controlled, the remuneration amount determination unit 45E may change the remuneration amount according to the change in difficulty level.

For example, in a case where a mobile object 10 existing in an environment of low difficulty level is scheduled to be remotely controlled, but the difficulty level of the remote control increases due to a change in the environment around the mobile object 10, the remuneration amount determination unit 45E changes the remuneration amount to be increased.

The environment of low difficulty level is, for example, a case where the density of people existing around the mobile object 10 that is a remote control target is less than a threshold, a case where the width of the route along which the mobile object 10 travels is equal to or greater than a threshold, or the like. The environment of high difficulty level is, for example, a case where the density of people existing around the mobile object 10 that is a remote control target is equal to or greater than a threshold, a case where the width of the route along which the mobile object 10 travels is less than a threshold, or the like.

### Nineteenth Modification

In the present modification, the remuneration amount determination unit 45E determines a remuneration amount depending on the difference between the number of recruited persons and the number of applicants for remote operators Q.

It is assumed that the information processing apparatus 40 recruits remote operators Q who remotely control mobile objects 10. In this case, the remuneration amount determination unit 45E may determine a remuneration amount depending on the difference between the number of recruited persons and the actual number of applicants.

For example, when the number of recruited persons ≤the number of applicants, the remuneration amount determination unit 45E does not change the determined remuneration amount. On the other hand, when the number of recruited persons >the number of applicants, the remuneration amount determination unit 45E increases the determined remuneration amount.

In addition, the remuneration amount determination unit 45E may determine a remuneration amount depending on a ratio of the number of applicants to the number of recruited persons, instead of the number of applicants relative to the number of recruited persons.

In addition, the remuneration amount determination unit 45E may determine a remuneration amount depending on the time remaining until the application deadline.

For example, in a case where the time remaining until the application deadline is 10 minutes, when the number of recruited persons>the number of applicants, the remuneration amount determination unit 45E may change the determined remuneration amount to be increased by a predetermined amount. In addition, in a case where the time remaining until the application deadline is 5 minutes, when the number of recruited persons>the number of applicants, the remuneration amount determination unit 45E may change the determined remuneration amount to be increased by an amount higher than the predetermined amount.

### Twentieth Modification

In the present modification, in a case where remote control is used for enabling a mobile object 10 to travel along a shortcut travel route, the remuneration amount determination unit 45E determines a remuneration amount higher than that for remote control based on remote control request information.

If a delay occurs in the service provided by the mobile object 10, the quality of the service deteriorates. Therefore, the service manager P has a need to suppress the delay if possible. Therefore, the service manager P wants to use remote control if the remote control enables a mobile object 10 to travel along a shortcut travel route. On the other hand, in a case where the remote control is requested even though the mobile object 10 can travel by autonomous driving, an unnecessary load is applied to the remote operator Q, and the cost also increases.

Therefore, in a case where remote control for enabling a mobile object 10 to take a shortcut travel route, the remuneration amount determination unit 45E determines a remuneration amount higher than that for remote control based on remote control request information. In addition, the remuneration amount determination unit 45E may similarly determine an amount charging the service manager P instead of the remuneration amount to the remote operator Q. In this case, the remuneration amount determination unit 45E may determine the charge amount to be an amount higher than usual.

For example, the control unit 45 of the information processing apparatus 40 sets a point where a shortcut can be taken in map information in advance and stores the shortcut available point in the storage unit 44 in advance. Then, the execution operator determination unit 45C of the information processing apparatus 40 determines whether or not the mobile object 10 will pass through the point where the shortcut can be taken by using movement schedule information of the mobile object 10 stored in advance in the storage unit 44. Then, when it is determined that the mobile object 10 will pass through the point where the shortcut can be taken, the execution operator determination unit 45C transmits inquiry information about whether to take the shortcut to the service manager terminal 20 of the service manager P. In this case, the execution operator determination unit 45C transmits inquiry information including information on a fee for remote control along the shortcut route.

In a case where the service manager P inputs information indicating consent to the inquiry information by operating the input unit 22, the control unit 25 of the service manager terminal 20 transmits the information indicating consent to the information processing apparatus 40. In a case where the information indicating the consent is received from the service manager terminal 20, when the mobile object 10 reaches the point where the shortcut can be taken, the execution operator determination unit 45C of the information processing apparatus 40 determines an execution operator who executes remote control for changing the travel route of the mobile object 10 to the shortcut route.

Note that the control unit 45 of the information processing apparatus 40 may transmit inquiry information about whether to take the shortcut to the service manager terminal 20 only in a case where a delay has occurred in the service provided by the mobile object 10. This is to prevent the inquiry information from being transmitted from the information processing apparatus 40 to the service manager terminal 20 even though the service is not delayed.

Furthermore, in a case where a delay has occurred in the service provided by the mobile object 10, when the mobile object 10 reaches the point where the shortcut can be taken, the control unit 45 of the information processing apparatus 40 may determine an execution operator who executes remote control for changing the travel route of the mobile object 10 to the shortcut route without transmitting the inquiry information to the service manager terminal 20.

With this determination processing, the control unit 45 can reduce the burden on the service manager P by transmitting the inquiry information, shorten the time for determining the execution operator, and shorten the time until the start of the remote control.

Next, an example of a hardware configuration of the mobile object 10, the service manager terminal 20, the remote control terminal 30, and the information processing apparatus 40 according to the above-described embodiment and modifications will be described.

FIG. 12 is a diagram of an example of a hardware configuration of the mobile object 10, the service manager terminal 20, the remote control terminal 30, and the information processing apparatus 40 according to the above-described embodiment and modifications of the above-described embodiment.

The mobile object 10, the service manager terminal 20, the remote control terminal 30, and the information processing apparatus 40 according to the above-described embodiment and modifications of the above-described embodiment have a hardware configuration using a normal computer in which a central processing unit (CPU) 80, a read only memory (ROM) 82, a random access memory (RAM) 84, an I/F 86, etc. are connected to each other via a bus 88.

The CPU 80 is an arithmetic device that controls the mobile object 10, the service manager terminal 20, the remote control terminal 30, and the information processing apparatus 40 of above-described embodiment and modifications. The ROM 82 stores programs and the like that realize information processing performed by the CPU 80. The RAM 84 stores data necessary for various processes performed by the CPU 80. The I/F 86 is an interface connected to the storage unit, the input unit, the output unit, the sensor, the communication unit, etc., to transmit and receive data.

In the mobile object 10, the service manager terminal 20, the remote control terminal 30, and the information processing apparatus 40 according to the above-described embodiment and modifications of the above-described embodiment, the CPU 80 reads a program from the ROM 82 onto the RAM 84 and executes the program, whereby each of the above-described functional units is realized on the computer.

Note that the program for executing each of the above-described processes executed by the mobile object 10, the service manager terminal 20, the remote control terminal 30, and the information processing apparatus 40 according to the above-described embodiment and modifications may be stored in a hard disk drive (HDD). In addition, the program for executing each of the above-described processes executed by the mobile object 10, the service manager terminal 20, the remote control terminal 30, and the information processing apparatus 40 according to the above-described embodiment and modifications may be provided by being incorporated in the ROM 82 in advance.

Furthermore, the programs for executing the above-described processes executed by the mobile object 10, the service manager terminal 20, the remote control terminal 30, and the information processing apparatus 40 according to the above-described embodiment and modifications may be stored as a file in an installable format or an executable format in a computer-readable storage medium such as a CD-ROM, a CD-R, a memory card, a digital versatile disk (DVD), or a flexible disk (FD), and provided as a computer program product. Furthermore, the program for executing the above-described information processing executed by the mobile object 10, the service manager terminal 20, the remote control terminal 30, and the information processing apparatus 40 according to the above-described embodiment and modifications may be stored on a computer connected to a network such as the Internet, and provided by being downloaded via the network. Furthermore, the program for executing the above-described information processing executed by the mobile object 10, the service manager terminal 20, the remote control terminal 30, and the information processing apparatus 40 according to the above-described embodiment and modifications may be provided or distributed via a network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Note that the present technology can also have the following configurations.

### 1

An information processing method executed by an information processing apparatus, the method including:
a receiving step of receiving remote control request information from a mobile object; and
an execution operator determination step of determining, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

### 2

The information processing method according to (1), in which
the execution operator determination step includes
determining, as the execution operator, the remote operator having a remote control history for an area under a traveling rule corresponding to a traveling area of the mobile object from which the remote control request information is transmitted.

### 3

The information processing method according to (1) or 1 (2), in which
the execution operator determination step includes
in a case where the remote control request information is received or has been received multiple times from the same mobile object within a predetermined range in terms of time or distance, determining the same remote operator as the execution operator for the remote control request information multiple times.

### 4

The information processing method according to any one of (1) to (3), in which
the execution operator determination step includes
in a case where a plurality of pieces of the remote control request information are received or have been received from mobile objects in the same area within a predetermined period, determining the same remote operator as the execution operator for the plurality of pieces of remote control request information.

### 5

The information processing method according to any one of (1) to (4), in which
the execution operator determination step includes
determining, as the execution operator, the remote operator who has remotely controlled, within a predetermined period from reception of the remote control request information, a mobile object similar to the mobile object from which the remote control request information is transmitted.

### 6

The information processing method according to any one of (1) to (5), in which
the execution operator determination step includes
determining, as the execution operator, the remote operator for whom a predetermined time or more has elapsed since previous remote control.

### 7

The information processing method according to any one of (1) to (6), in which
the execution operator determination step includes
determining, as the execution operator, the remote operator having a history of checking a traveling rule of a traveling area of the mobile object from which remote control request information is transmitted.

### 8

The Information Processing Method According to Any One of (1) to (7), in which
the execution operator determination step includes
in a case where a traveling situation of the mobile object from which the remote control request information is transmitted is a predetermined situation requiring a high level of remote control ability, determining, as the execution operator, the remote operator whose required time for remotely controlling the mobile object in the traveling situation has been a predetermined time or less.

### 9

The information processing method according to any one of (1) to (8), in which
the execution operator determination step includes
determining, as the execution operator, the remote operator who is remotely monitoring a traveling area of the mobile object from which the remote control request information is transmitted.

### 10

The information processing method according to any one of (1) to (9), in which
the execution operator determination step includes
determining, as the execution operator, the same remote operator for a plurality of mobile objects performing cooperative operations with the mobile object from which the remote control request information is transmitted.

### 11

The information processing method according to any one of (1) to (10), in which
the execution operator determination step includes
determining, as the execution operator, the remote operator satisfying the service manager-requested condition and a remote operator-requested condition of the remote operator.

### 12

The information processing method according to any one of (1) to (11), further including
a remuneration amount determination step of determining a remuneration amount for the execution operator according to at least one of the remote control request information, a status of determination made by the execution operator, and a status of remote control performed by the execution operator.

### 13

The information processing method according to any one of (1) to (12), further including
a transmission control step of transmitting remote control support request information to a remote control terminal operated by the execution operator.

### 14

An information processing program executed by a computer of an information processing apparatus, the program causing the computer to perform:
a receiving step of receiving remote control request information from a mobile object; and
an execution operator determination step of determining, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

### 15

An information processing apparatus including:
a receiving unit configured to receive remote control request information from a mobile object; and
an execution operator determination unit configured to determine, based on the remote control request information, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

What is claimed is:

1. An information processing method executed by an information processing apparatus, the method comprising:
receiving remote control request information from a mobile object; and
determining, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

2. The information processing method according to claim 1, wherein
the determining comprises
determining, as the execution operator, the remote operator having a remote control history for an area under a traveling rule corresponding to a traveling area of the mobile object from which the remote control request information is transmitted.

3. The information processing method according to claim 1, wherein
the determining comprises
in a case where the remote control request information is received or has been received multiple times from the same mobile object within a predetermined range in terms of time or distance, determining the same remote operator as the execution operator for the remote control request information multiple times.

4. The information processing method according to claim 1, wherein
the determining comprises
in a case where a plurality of pieces of the remote control request information are received or have been received from mobile objects in the same area within a predetermined period, determining the same remote operator as the execution operator for the plurality of pieces of remote control request information.

5. The information processing method according to claim 1, wherein
the determining comprises
determining, as the execution operator, the remote operator who has remotely controlled, within a predetermined period from reception of the remote control request information, a mobile object similar to the mobile object from which the remote control request information is transmitted.

6. The information processing method according to claim 1, wherein
the determining comprises
determining, as the execution operator, the remote operator for whom a predetermined time or more has elapsed since previous remote control.

7. The information processing method according to claim 1, wherein
the determining comprises
determining, as the execution operator, the remote operator having a history of checking a traveling rule of a traveling area of the mobile object from which remote control request information is transmitted.

8. The information processing method according to claim 1, wherein
the determining comprises
in a case where a traveling situation of the mobile object from which the remote control request information is transmitted is a predetermined situation requiring a high level of remote control ability, determining, as the execution operator, the remote operator whose required time for remotely controlling the mobile object in the traveling situation has been a predetermined time or less.

9. The information processing method according to claim 1, wherein
the determining comprises
determining, as the execution operator, the remote operator who is remotely monitoring a traveling area of the mobile object from which the remote control request information is transmitted.

10. The information processing method according to claim 1, wherein
the determining comprises
determining, as the execution operator, the same remote operator for a plurality of mobile objects performing cooperative operations with the mobile object from which the remote control request information is transmitted.

11. The information processing method according to claim 1, wherein
the determining comprises
determining, as the execution operator, the remote operator satisfying the service manager-requested condition and a remote operator-requested condition representing a condition requested by the remote operator regarding allocating the remote operator who remotely controls the mobile object.

12. The information processing method according to claim 1, further comprising
determining a remuneration amount for the execution operator according to at least one of the remote control request information, a status of determination made by the execution operator, and a status of remote control performed by the execution operator.

13. The information processing method according to claim 1, further comprising
transmitting remote control support request information to a remote control terminal operated by the execution operator.

14. A computer program product including programmed instructions embodied in and stored on a non-transitory computer readable medium, wherein the instructions, when executed by a computer an information processing apparatus, cause the computer to perform:
receiving remote control request information from a mobile object; and
determining, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.

15. An information processing apparatus comprising:
a memory; and
a hardware processor coupled to the memory and configured to:
receive remote control request information from a mobile object; and
determine, based on the remote control request information, based on the remote control request information, a remote operator satisfying a service manager-requested condition representing a condition requested by a service manager regarding allocating the remote operator who remotely controls the mobile object, as an execution operator who remotely controls the mobile object from which the remote control request information is transmitted.
